(19) United States
(12) Patent Application Publication
(10) Pub. No.: US 2026/0163609 A1
(43) Pub. Date: Jun. 11, 2026

(54) USAGE OF A RECONFIGURABLE INTELLIGENT SURFACE IN WIRELESS COMMUNICATIONS

(71) Applicant: QUALCOMM Incorporated, San Diego, CA (US)

(72) Inventors: Saeid SAHRAEI, San Diego, CA (US); Naga BHUSHAN, San Diego, CA (US); Yu ZHANG, San Diego, CA (US); Peter GAAL, San Diego, CA (US); Hung Dinh LY, San Diego, CA (US); Krishna Kiran MUKKAVILLI, San Diego, CA (US)

(21) Appl. No.: 18/706,681

(22) PCT Filed: Jan. 7, 2022
(86) PCT No.: PCT/CN2022/070655

§ 371 Date: May 1, 2024

(51) Int. Cl. H04B 7/04; H04W 24/02; H04W 74/0833

(52) U.S. Cl. CPC H04B 7/04013; H04W 24/02; H04W 74/0833

(57) ABSTRACT

Methods, systems, and devices for wireless communications are described. Generally, the described techniques provide for control of a reconfigurable intelligent surface (RIS) and for beam selection at a base station based on feedback from a user equipment (UE). In some examples, the feedback may be based on a variance threshold of a reference signal received power for a set of reference signals transmitted by the base station and associated with a beam directed toward a RIS. In some examples, the feedback may be based on a received power comparison between a probe or reference beam and a set of reference signals transmitted by the base station and associated with a beam directed toward a RIS. The base station and the UE may communicate via using the RIS or not using the RIS based on the feedback.

### CROSS REFERENCE

The present Application is a 371 national phase filing of International PCT Application No. PCT/CN2022/070655 by SAHRAEI et al., entitled “USAGE OF A RECONFIGURABLE INTELLIGENT SURFACE IN WIRELESS COMMUNICATIONS,” filed Jan. 7, 2022, which is assigned to the assignee hereof, and which is expressly incorporated by reference in its entirety herein.

### FIELD OF TECHNOLOGY

The following relates to wireless communications, including methods for usage of a reconfigurable intelligent surface (RIS) in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support methods for usage of a reconfigurable intelligent surface (RIS) in wireless communications. Generally, the described techniques provide for control of a RIS and for beam selection at a base station based on feedback from a user equipment (UE). In some examples, a base station may configure a UE with a variance threshold.

The base station may transmit a number of reference signals associated with one or more beams directed toward a RIS. The UE may compute a variance of the received power of the reference signals transmitted by the base station. If the variance of the received power of the reference signals is less than the variance threshold, the UE may indicate to the base station that the UE may communicate with the base station without using the RIS. If the variance of the received power of the reference signals is greater that the variance threshold, the UE may indicate to the base station to use the RIS for communications with the UE.

In some examples, the base station may configure a reference beam (e.g., a probe beam). The base station may transmit a set of reference signals associated with one or more beams directed toward a RIS and a probe reference signal corresponding to the probe beam directed toward the RIS. The base station may indicate to the UE and the RIS which reference signal corresponds to the probe beam. The base station may configure the RIS to operate in a reflecting mode for the set of reference signals and to operate in a non-reflecting mode (e.g., in a transparent mode or a scattering mode) for the probe reference signal. The base station may also indicate a received power difference threshold to the UE. The UE may compare the respective received power difference between each of the set of reference signals and the probe reference signal to the received power difference threshold. If the received power difference between each of the set of reference signals and the probe reference signal is less than the configured received power difference threshold, the UE may report the probe reference signal to the base station as being associated with the best beam, and the UE and the base station may communicate without the use of the RIS. If the received power difference between any of the set of reference signals and the probe reference signal exceeds the configured received power difference threshold, the UE may report one of the set of reference signals as being associated with the strongest beam. The UE and the base station may communicate using the RIS based on the reported strongest beam.

A method for wireless communications at a UE is described. The method may include receiving a first message that indicates a variance threshold associated with measurement of one or more reference signals by the UE, receiving a first reference signal and a second reference signal of the one or more reference signals, where both the first reference signal and the second reference signal are associated with a beam directed toward a RIS, measuring a variance associated with the first and second reference signals, and transmitting a second message associated with control of the RIS based on the measured variance associated with the first and second reference signals and the variance threshold.

An apparatus for wireless communications at a UE is described. The apparatus may include a processor, memory coupled with the processor, and instructions stored in the memory. The instructions may be executable by the processor to cause the apparatus to receive a first message that indicates a variance threshold associated with measurement of one or more reference signals by the UE, receive a first reference signal and a second reference signal of the one or more reference signals, where both the first reference signal and the second reference signal are associated with a beam directed toward a RIS, measure a variance associated with the first and second reference signals, and transmit a second message associated with control of the RIS based on the measured variance associated with the first and second reference signals and the variance threshold.

Another apparatus for wireless communications at a UE is described. The apparatus may include means for receiving a first message that indicates a variance threshold associated with measurement of one or more reference signals by the UE, means for receiving a first reference signal and a second reference signal of the one or more reference signals, where both the first reference signal and the second reference signal are associated with a beam directed toward a RIS, means for measuring a variance associated with the first and second reference signals, and means for transmitting a second message associated with control of the RIS based on the measured variance associated with the first and second reference signals and the variance threshold.

A non-transitory computer-readable medium storing code for wireless communications at a UE is described. The code may include instructions executable by a processor to receive a first message that indicates a variance threshold associated with measurement of one or more reference signals by the UE, receive a first reference signal and a second reference signal of the one or more reference signals, where both the first reference signal and the second reference signal are associated with a beam directed toward a RIS, measure a variance associated with the first and second reference signals, and transmit a second message associated with control of the RIS based on the measured variance associated with the first and second reference signals and the variance threshold.

Some examples of the method, apparatuses, and non-transitory computer-readable medium described herein may further include operations, features, means, or instructions for receiving a third message indicating a set of multiple synchronization signal block indices, where each of the one or more reference signals includes a respective synchronization signal block signal associated with a respective synchronization signal block index.

In some examples of the method, apparatuses, and non-transitory computer-readable medium described herein, receiving the third message may include operations, features, means, or instructions for receiving a raster grid including frequency positions associated with the RIS.

Some examples of the method, apparatuses, and non-transitory computer-readable medium described herein may further include operations, features, means, or instructions for monitoring one or more resource elements for the respective synchronization signal block signals based on the raster grid, where receiving the first reference signal and the second reference signal may be based on the monitoring.

In some examples of the method, apparatuses, and non-transitory computer-readable medium described herein, measuring the variance may include operations, features, means, or instructions for measuring a reference signal received power variance associated with the first and second reference signals.

In some examples of the method, apparatuses, and non-transitory computer-readable medium described herein, transmitting the second message may include operations, features, means, or instructions for transmitting the second message in a random access procedure transmission.

In some examples of the method, apparatuses, and non-transitory computer-readable medium described herein, transmitting the second message may include operations, features, means, or instructions for transmitting a first indication to disable the RIS for communications with the UE based on the measured variance associated with the first and second reference signals not satisfying the variance threshold, or transmitting a second indication to enable the RIS for communications with the UE based on the measured variance associated with the first and second reference signals satisfying the variance threshold.

A method for wireless communications at a base station is described. The method may include transmitting a first message that indicates a variance threshold associated with measurement of one or more reference signals by a UE, transmitting a first reference signal and a second reference signal of the one or more reference signals, where both the first reference signal and the second reference signal are associated with a beam directed toward a RIS, and receiving, from the UE, a second message associated with control of the RIS based on a measured variance associated with the first and second reference signals and the variance threshold.

An apparatus for wireless communications at a base station is described. The apparatus may include a processor, memory coupled with the processor, and instructions stored in the memory. The instructions may be executable by the processor to cause the apparatus to transmit a first message that indicates a variance threshold associated with measurement of one or more reference signals by a UE, transmit a first reference signal and a second reference signal of the one or more reference signals, where both the first reference signal and the second reference signal are associated with a beam directed toward a RIS, and receive, from the UE, a second message associated with control of the RIS based on a measured variance associated with the first and second reference signals and the variance threshold.

Another apparatus for wireless communications at a base station is described. The apparatus may include means for transmitting a first message that indicates a variance threshold associated with measurement of one or more reference signals by a UE, means for transmitting a first reference signal and a second reference signal of the one or more reference signals, where both the first reference signal and the second reference signal are associated with a beam directed toward a RIS, and means for receiving, from the UE, a second message associated with control of the RIS based on a measured variance associated with the first and second reference signals and the variance threshold.

A non-transitory computer-readable medium storing code for wireless communications at a base station is described. The code may include instructions executable by a processor to transmit a first message that indicates a variance threshold associated with measurement of one or more reference signals by a UE, transmit a first reference signal and a second reference signal of the one or more reference signals, where both the first reference signal and the second reference signal are associated with a beam directed toward a RIS, and receive, from the UE, a second message associated with control of the RIS based on a measured variance associated with the first and second reference signals and the variance threshold.

Some examples of the method, apparatuses, and non-transitory computer-readable medium described herein may further include operations, features, means, or instructions for transmitting a third message indicating a set of multiple synchronization signal block indices, where each of the one or more reference signals includes a respective synchronization signal block signal associated with a respective synchronization signal block index.

In some examples of the method, apparatuses, and non-transitory computer-readable medium described herein, transmitting the third message may include operations, features, means, or instructions for transmitting a raster grid including frequency positions associated with the RIS.

In some examples of the method, apparatuses, and non-transitory computer-readable medium described herein, receiving the second message may include operations, features, means, or instructions for receiving the second message in a random access procedure transmission.

In some examples of the method, apparatuses, and non-transitory computer-readable medium described herein, receiving the second message may include operations, features, means, or instructions for receiving a first indication to disable the RIS for communications with the UE based on the measured variance associated with the first and second reference signals not satisfying the variance threshold, or receiving a second indication to enable the RIS for communications with the UE based on the measured variance associated with the first and second reference signals satisfying the variance threshold.

Some examples of the method, apparatuses, and non-transitory computer-readable medium described herein may further include operations, features, means, or instructions for transmitting, to the RIS, first control signaling indicating to disable the RIS for communications with the UE based on receiving the first indication and transmitting, to the RIS, second control signaling indicating to enable the RIS for communications with the UE based on receiving the second indication.

A method for wireless communications at a UE is described. The method may include receiving a first message that indicates one or more reference signals associated with a beam directed toward a RIS, a probe reference signal, and a received power difference threshold, receiving the probe reference signal and a first reference signal and a second reference signal of the one or more reference signals, and transmitting, to a base station, a second message indicating a selected reference signal based on a first comparison of a first received power difference between the first reference signal and the probe reference signal to the received power difference threshold and a second comparison of a second received power difference between the second reference signal and the probe reference signal to the received power difference threshold.

An apparatus for wireless communications at a UE is described. The apparatus may include a processor, memory coupled with the processor, and instructions stored in the memory. The instructions may be executable by the processor to cause the apparatus to receive a first message that indicates one or more reference signals associated with a beam directed toward a RIS, a probe reference signal, and a received power difference threshold, receive the probe reference signal and a first reference signal and a second reference signal of the one or more reference signals, and transmit, to a base station, a second message indicating a selected reference signal based on a first comparison of a first received power difference between the first reference signal and the probe reference signal to the received power difference threshold and a second comparison of a second received power difference between the second reference signal and the probe reference signal to the received power difference threshold.

Another apparatus for wireless communications at a UE is described. The apparatus may include means for receiving a first message that indicates one or more reference signals associated with a beam directed toward a RIS, a probe reference signal, and a received power difference threshold, means for receiving the probe reference signal and a first reference signal and a second reference signal of the one or more reference signals, and means for transmitting, to a base station, a second message indicating a selected reference signal based on a first comparison of a first received power difference between the first reference signal and the probe reference signal to the received power difference threshold and a second comparison of a second received power difference between the second reference signal and the probe reference signal to the received power difference threshold.

A non-transitory computer-readable medium storing code for wireless communications at a UE is described. The code may include instructions executable by a processor to receive a first message that indicates one or more reference signals associated with a beam directed toward a RIS, a probe reference signal, and a received power difference threshold, receive the probe reference signal and a first reference signal and a second reference signal of the one or more reference signals, and transmit, to a base station, a second message indicating a selected reference signal based on a first comparison of a first received power difference between the first reference signal and the probe reference signal to the received power difference threshold and a second comparison of a second received power difference between the second reference signal and the probe reference signal to the received power difference threshold.

In some examples of the method, apparatuses, and non-transitory computer-readable medium described herein, transmitting the second message may include operations, features, means, or instructions for transmitting an indication that the probe reference signal may be the selected reference signal based on the first received power difference and the second received power difference not satisfying the received power difference threshold.

In some examples of the method, apparatuses, and non-transitory computer-readable medium described herein, transmitting the second message may include operations, features, means, or instructions for transmitting an indication that one of the first reference signal or the second reference signal may be the selected reference signal based on one of the first received power difference or the second received power difference satisfying the received power difference threshold.

Some examples of the method, apparatuses, and non-transitory computer-readable medium described herein may further include operations, features, means, or instructions for receiving a third message indicating a set of multiple synchronization signal block indices, where each of the one or more reference signals and the probe reference signal includes a synchronization signal block signal associated with a respective synchronization signal block index.

In some examples of the method, apparatuses, and non-transitory computer-readable medium described herein, receiving the third message may include operations, features, means, or instructions for receiving a raster grid including frequency positions associated with the RIS.

Some examples of the method, apparatuses, and non-transitory computer-readable medium described herein may further include operations, features, means, or instructions for monitoring one or more resource elements for the respective synchronization signal block signals based on the raster grid, where receiving the probe reference signal and the first reference signal and the second reference signal may be based on the monitoring.

In some examples of the method, apparatuses, and non-transitory computer-readable medium described herein, the probe reference signal may be associated with one of a lowest index or a highest index of the set of multiple synchronization signal block indices.

Some examples of the method, apparatuses, and non-transitory computer-readable medium described herein may further include operations, features, means, or instructions for measuring a first reference signal received power of the first reference signal, a second reference signal received power of the second reference signal, and a third reference signal received power of the probe reference signal, where the first comparison and the second comparison may be based on the first reference signal received power, the second reference signal received power, and the third reference signal received power.

In some examples of the method, apparatuses, and non-transitory computer-readable medium described herein, transmitting the second message may include operations, features, means, or instructions for transmitting the second message in a random access procedure transmission.

A method for wireless communications at a base station is described. The method may include transmitting a first message that indicates a one or more reference signals associated with a beam directed toward a RIS, a probe reference signal, and a received power difference threshold, transmitting, to the RIS, a second message indicating to reflect the one or more reference signals and to refrain from reflecting the probe reference signal, transmitting the probe reference signal and a first reference signal and a second reference signal of the one or more reference signals, and receiving a third message indicating a selected reference signal based on a first comparison of a first received power difference between the first reference signal and the probe reference signal to the received power difference threshold and a second comparison of a second received power difference between the second reference signal and the probe reference signal to the received power difference threshold.

An apparatus for wireless communications at a base station is described. The apparatus may include a processor, memory coupled with the processor, and instructions stored in the memory. The instructions may be executable by the processor to cause the apparatus to transmit a first message that indicates a one or more reference signals associated with a beam directed toward a RIS, a probe reference signal, and a received power difference threshold, transmit, to the RIS, a second message indicating to reflect the one or more reference signals and to refrain from reflecting the probe reference signal, transmit the probe reference signal and a first reference signal and a second reference signal of the one or more reference signals, and receive a third message indicating a selected reference signal based on a first comparison of a first received power difference between the first reference signal and the probe reference signal to the received power difference threshold and a second comparison of a second received power difference between the second reference signal and the probe reference signal to the received power difference threshold.

Another apparatus for wireless communications at a base station is described. The apparatus may include means for transmitting a first message that indicates a one or more reference signals associated with a beam directed toward a RIS, a probe reference signal, and a received power difference threshold, means for transmitting, to the RIS, a second message indicating to reflect the one or more reference signals and to refrain from reflecting the probe reference signal, means for transmitting the probe reference signal and a first reference signal and a second reference signal of the one or more reference signals, and means for receiving a third message indicating a selected reference signal based on a first comparison of a first received power difference between the first reference signal and the probe reference signal to the received power difference threshold and a second comparison of a second received power difference between the second reference signal and the probe reference signal to the received power difference threshold.

A non-transitory computer-readable medium storing code for wireless communications at a base station is described. The code may include instructions executable by a processor to transmit a first message that indicates a one or more reference signals associated with a beam directed toward a RIS, a probe reference signal, and a received power difference threshold, transmit, to the RIS, a second message indicating to reflect the one or more reference signals and to refrain from reflecting the probe reference signal, transmit the probe reference signal and a first reference signal and a second reference signal of the one or more reference signals, and receive a third message indicating a selected reference signal based on a first comparison of a first received power difference between the first reference signal and the probe reference signal to the received power difference threshold and a second comparison of a second received power difference between the second reference signal and the probe reference signal to the received power difference threshold.

In some examples of the method, apparatuses, and non-transitory computer-readable medium described herein, receiving the third message may include operations, features, means, or instructions for receiving an indication that the probe reference signal may be the selected reference signal based on the first received power difference and the second received power difference not satisfying the received power difference threshold.

In some examples of the method, apparatuses, and non-transitory computer-readable medium described herein, receiving the third message may include operations, features, means, or instructions for receiving an indication that one of the first reference signal or the second reference signal may be the selected reference signal based on one of the first received power difference or the second received power difference satisfying the received power difference threshold.

Some examples of the method, apparatuses, and non-transitory computer-readable medium described herein may further include operations, features, means, or instructions for transmitting a fourth message indicating a set of multiple synchronization signal block indices, where each of the one or more reference signals and the probe reference signal includes a synchronization signal block signal associated with a respective synchronization signal block index.

In some examples of the method, apparatuses, and non-transitory computer-readable medium described herein, transmitting the fourth message may include operations, features, means, or instructions for transmitting a raster grid including frequency positions associated with the RIS.

In some examples of the method, apparatuses, and non-transitory computer-readable medium described herein, the probe reference signal may be associated with one of a lowest index or a highest index of the set of multiple synchronization signal block indices.

In some examples of the method, apparatuses, and non-transitory computer-readable medium described herein, receiving the third message may include operations, features, means, or instructions for receiving the third message in a random access procedure transmission.

A method for wireless communications at a RIS is described. The method may include receiving, from a base station, a message instructing the RIS to operate in a first mode for each of a set of multiple transmissions from the base station and to operate in a second mode for a probe transmission from the base station, where each of the set of multiple transmissions and the probe transmission are associated with a same beam direction, reflecting, by the RIS operating in the first mode, the set of multiple transmissions from the base station, and refraining from reflecting, by the RIS operating in the second mode, the probe transmission from the base station.

An apparatus for wireless communications at a RIS is described. The apparatus may include a processor, memory coupled with the processor, and instructions stored in the memory. The instructions may be executable by the processor to cause the apparatus to receive, from a base station, a message instructing the RIS to operate in a first mode for each of a set of multiple transmissions from the base station and to operate in a second mode for a probe transmission from the base station, where each of the set of multiple transmissions and the probe transmission are associated with a same beam direction, reflect, by the RIS operating in the first mode, the set of multiple transmissions from the base station, and refrain from reflecting, by the RIS operating in the second mode, the probe transmission from the base station.

Another apparatus for wireless communications at a RIS is described. The apparatus may include means for receiving, from a base station, a message instructing the RIS to operate in a first mode for each of a set of multiple transmissions from the base station and to operate in a second mode for a probe transmission from the base station, where each of the set of multiple transmissions and the probe transmission are associated with a same beam direction, means for reflecting, by the RIS operating in the first mode, the set of multiple transmissions from the base station, and means for refraining from reflecting, by the RIS operating in the second mode, the probe transmission from the base station.

A non-transitory computer-readable medium storing code for wireless communications at a RIS is described. The code may include instructions executable by a processor to receive, from a base station, a message instructing the RIS to operate in a first mode for each of a set of multiple transmissions from the base station and to operate in a second mode for a probe transmission from the base station, where each of the set of multiple transmissions and the probe transmission are associated with a same beam direction, reflect, by the RIS operating in the first mode, the set of multiple transmissions from the base station, and refrain from reflecting, by the RIS operating in the second mode, the probe transmission from the base station.

In some examples of the method, apparatuses, and non-transitory computer-readable medium described herein, operating in the first mode may include operations, features, means, or instructions for operating in a reflecting mode.

In some examples of the method, apparatuses, and non-transitory computer-readable medium described herein, operating in the second mode may include operations, features, means, or instructions for operating in a scattering mode or in a transparent mode.

Some examples of the method, apparatuses, and non-transitory computer-readable medium described herein may further include operations, features, means, or instructions for receiving a second message indicating a set of multiple synchronization signal block indices, where each of the set of multiple transmissions and the probe transmission includes a synchronization signal block signal associated with a respective synchronization signal block index.

In some examples of the method, apparatuses, and non-transitory computer-readable medium described herein, the probe transmission may be associated with one of a lowest index or a highest index of the set of multiple synchronization signal block indices.

### BRIEF DESCRIPTION OF THE DRAWINGS

FIG. 1 illustrates an example of a wireless communications system that supports methods for usage of a reconfigurable intelligent surface (RIS) in wireless communications in accordance with aspects of the present disclosure.

FIG. 2 illustrates an example of a wireless communications system that supports methods for usage of a RIS in wireless communications in accordance with aspects of the present disclosure.

FIG. 3 illustrates an example of a resource mapping scheme that supports methods for usage of a RIS in wireless communications in accordance with aspects of the present disclosure.

FIG. 4 illustrates an example of a beam sweeping scheme that supports methods for usage of a RIS in wireless communications in accordance with aspects of the present disclosure.

FIG. 5 illustrates an example of a beam sweeping scheme that supports methods for usage of a RIS in wireless communications in accordance with aspects of the present disclosure.

FIG. 6 illustrates an example of a beam sweeping scheme that supports methods for usage of a RIS in wireless communications in accordance with aspects of the present disclosure.

FIG. 7 illustrates an example of a process flow that supports methods for usage of a RIS in wireless communications in accordance with aspects of the present disclosure.

FIG. 8 illustrates an example of a process flow that supports methods for usage of a RIS in wireless communications in accordance with aspects of the present disclosure.

FIGS. 9 and 10 show block diagrams of devices that support methods for usage of a RIS in wireless communications in accordance with aspects of the present disclosure.

FIG. 11 shows a block diagram of a communications manager that supports methods for usage of a RIS in wireless communications in accordance with aspects of the present disclosure.

FIG. 12 shows a diagram of a system including a device that supports methods for usage of a RIS in wireless communications in accordance with aspects of the present disclosure.

FIGS. 13 and 14 show block diagrams of devices that support methods for usage of a RIS in wireless communications in accordance with aspects of the present disclosure.

FIG. 15 shows a block diagram of a communications manager that supports methods for usage of a RIS in wireless communications in accordance with aspects of the present disclosure.

FIG. 16 shows a diagram of a system including a device that supports methods for usage of a RIS in wireless communications in accordance with aspects of the present disclosure.

FIGS. 17 and 18 show block diagrams of devices that support methods for usage of a RIS in wireless communications in accordance with aspects of the present disclosure.

FIG. 19 shows a block diagram of a communications manager that supports methods for usage of a RIS in wireless communications in accordance with aspects of the present disclosure.

FIG. 20 shows a diagram of a system including a device that supports methods for usage of a RIS in wireless communications in accordance with aspects of the present disclosure.

FIGS. 21 through 31 show flowcharts illustrating methods that support methods for usage of a RIS in wireless communications in accordance with aspects of the present disclosure.

### DETAILED DESCRIPTION

Some wireless communications such as fifth generation (5G) New Radio (NR) systems may employ reconfigurable intelligent surfaces (RISs) to extend wireless communications coverage, for example around or because of blockages, with negligible power consumption costs. RISs extend coverage by reflecting beams around blockages so that a base station may serve a user equipment (UE) in the presence of the blockages. During beam-sweeping, the base station may repeat a set of reference signals associated with one or more beams directed toward an RIS, and the RIS may perform beam sweeping. A UE may provide feedback to the base station indicating the strongest beam, and the base station may configure the base station's beam and the RIS's beam for communications with the UE according to the UE feedback. The feedback may not indicate, however, whether the strongest beam was received by the UE directly from the base station or via the RIS.

The present disclosure describes techniques for control of a RIS and for beam selection based on feedback from a UE. In some examples, a base station may configure a UE with a variance threshold. A base station may transmit a number of reference signals associated with one or more beams directed toward a RIS. The UE may compute a variance of the received power of the reference signals transmitted by the base station. If the variance of the received power of the reference signals is less than the variance threshold, the UE may indicate to the base station that the UE may communicate with the base station without using the RIS. If the variance of the received power of the reference signals is greater that the variance threshold, the UE may indicate to the base station to use the RIS for communications with the UE, and the base station may configure the base station's beam and the RIS's beam for communications with the UE according to the UE feedback.

In some examples, the base station may configure a reference beam (e.g., a probe beam). The base station may transmit a set of reference signals associated with one or more beams directed toward a RIS and a probe reference signal corresponding to the probe beam directed toward the RIS. The base station may indicate to the UE and the RIS which reference signal corresponds to the probe beam. The base station may configure the RIS to operate in a reflecting mode for the set of reference signals and to operate in a non-reflecting mode (e.g., in a transparent mode or a scattering mode) for the probe reference signal. The base station may also indicate a received power difference threshold to the UE. The UE may compare the respective received power difference between each of the set of reference signals and the probe reference signal to the received power difference threshold. If the received power difference between each of the set of reference signals and the probe reference signal is less than the configured received power difference threshold, the UE may report the probe reference signal to the base station as being associated with the best beam, and the UE and the base station may communicate without the use of the RIS. If the received power difference between any of the set of reference signals and the probe reference signal exceeds the configured received power difference threshold, the UE may report one of the set of reference signals as being associated with the strongest beam, and the base station may configure the base station's beam and the RIS's beam for communications with the UE according to the UE feedback. The UE and the base station may communicate using the RIS based on the indicated strongest beam.

Aspects of the disclosure are initially described in the context of wireless communications systems. Aspects of the disclosure are further illustrated by and described with reference to resource mapping schemes, beam sweeping schemes, and process flows. Aspects of the disclosure are further illustrated by and described with reference to apparatus diagrams, system diagrams, and flowcharts that relate to methods for usage of a RIS in wireless communications.

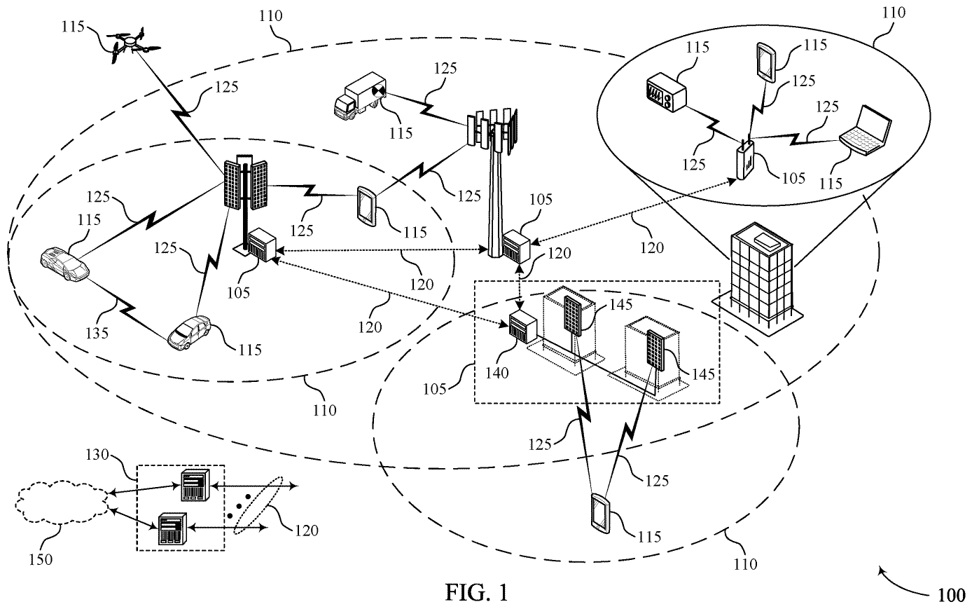

FIG. 1 illustrates an example of a wireless communications system 100 that supports methods for usage of a RIS in wireless communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, the wireless communications systems 100 may employ one or more RISs to extend wireless communications coverage, for example around or because of blockages between a base station 105 and a UE 115. In some examples, the base station 105 and the UE 115 may use techniques to determine whether the base station 105 and the UE 115 should communicate using a RIS. For example, a base station 105 may configure a UE 115 with a variance threshold. The base station 105 may transmit a number of reference signals associated with one or more beams directed toward a RIS. The UE 115 may compute a variance of the received power of the reference signals transmitted by the base station 105. If the variance of the received power of the reference signals is less than the variance threshold, the UE 115 may indicate to the base station 105 that the UE 115 may communicate with the base station 105 without using the RIS. If the variance of the received power of the reference signals is greater that the variance threshold, the UE 115 may indicate to the base station 105 to use the RIS for communications with the UE 115, and the base station 105 may configure the beam for the base station 105 and the beam for the RIS for communications with the UE 115 according to the UE feedback.

In some examples, the base station 105 may configure a reference beam (e.g., a probe beam). The base station 105 may transmit a set of reference signals associated with one or more beams directed toward a RIS and a probe reference signal corresponding to the probe beam directed toward the RIS. The base station 105 may indicate to the UE 115 and the RIS which reference signal corresponds to the probe beam. The base station 105 may configure the RIS to operate in a reflecting mode for the set of reference signals and to operate in a non-reflecting mode (e.g., in a transparent mode or a scattering mode) for the probe reference signal. The base station 105 may also indicate a received power difference threshold to the UE 115. The UE 115 may compare the respective received power difference between each of the set of reference signals and the probe reference signal to the received power difference threshold. If the received power difference between each of the set of reference signals and the probe reference signal is less than the configured received power difference threshold, the UE 115 may report the probe reference signal to the base station 105 as being associated with the best beam, and the UE 115 and the base station 105 may communicate without the use of the RIS. If the received power difference between any of the set of reference signals and the probe reference signal exceeds the configured received power difference threshold, the UE 115 may report one of the set of reference signals as being associated with the best beam. The UE 115 and the base station 105 may communicate using the RIS based on the indicated beam. The base station 105 may configure the beam for the base station 105 and the beam for the RIS for communications with the UE 115 according to the UE feedback.

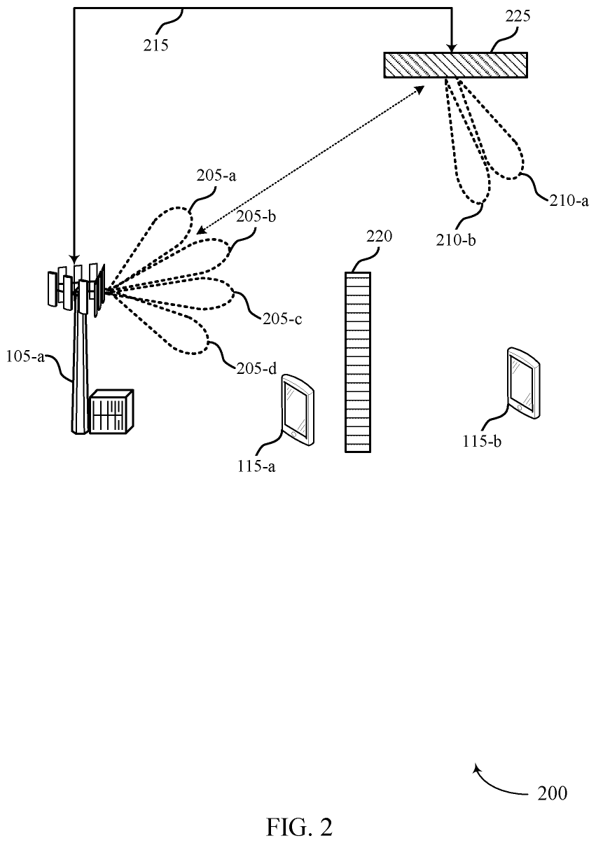

FIG. 2 illustrates an example of a wireless communications system 200 that supports methods for usage of a RIS in wireless communications in accordance with aspects of the present disclosure. In some examples, the wireless communications system 200 may be implemented by or may implement aspects of the wireless communications system 100 as described with reference to FIG. 1. The wireless communications system 200 may include a UE 115-a and a UE 115-b which may be examples of a UE 115 as described herein. The wireless communications system 200 may also include a base station 105-a which may be an example of a base station 105 as described herein. In some examples, the base station 105-a may communicate with the UE 115-a or the UE 115-b using directional communications techniques. For example, the base station 105-a may communicate with the UE 115-a or the UE 115-b via one or more beams 205.

The UEs 115-a or UE 115-b may perform an initial access procedure to establish a connection with the base station 105-a. Some initial access procedures may include the UE 115-a or the UE 115-b (or both) acquiring synchronization and system information from the base station 105-a via one or more synchronization signal blocks (SSBs), for example, sent on a physical broadcast channel (PBCH). For example, the base station 105-a may transmit (e.g., broadcast) one or more SSBs associated with the beams 205. In some implementations, the base station 105-a may transmit SSBs for each beam 205 using time division multiplexing techniques or using different frequency positions defined by a synchronization raster grid. The UE 115-a or the UE 115-b (or both) may receive at least one SSB based on which of the beams 205 UE 115-a or the UE 115-b (or both) monitor. For example, the UE 115-a may receive an SSB using the beam 205-d, but may not monitor any of the beams 205-a, 205-b, or 205-c.

In some examples, one or more beams 205 may be obstructed by a blockage 220 such that the base station 105-a may be unable to establish a connection with the UE 115-b. To mitigate the effects of the blockage 220, the wireless communications system 200 may include an RIS 225. The RIS 225 may reflect one or more beams 205 used by the base station 105-a. For example, the base station 105-a may transmit information using a beam 205-a, a beam 205-b, a beam 205-c, or a beam 205-d. In some examples, the beams 205-c and 205-d may be obstructed by the blockage 220 and so may not be used by the base station 105-a to communicate with the UE 115-b. The beams 205-a and 205-b, however, may not be obstructed by the blockage 220, but rather may be reflected by the RIS 225 to create a reflected beam 210-a and a reflected beam 210-b. The reflected beams 210-a and 210-b may bypass the blockage 220 and so may be used by the base station 105-a to communicate with the UE 115-b. In some examples, the base station 105-a may communicate with the RIS 225 via a link 215. In some implementations the link 215 may be unidirectional where the base station 105-a may communicate with the RIS 225 or the link 215 may be bi-directional where the RIS 225 may also communicate with the base station 105-a. Accordingly, the base station 105-a may adjust a set of phase weights, position, orientation, other factor, or any combination thereof of the RIS 225 to change a reflection direction of one or more beams 205. In some implementations, the RIS 225 may be an example of a near-passive device that exhibits a relatively low power consumption.

In such cases where the wireless communications system 200 uses the RIS 225, a path or channel between the base station 105-a and the UE 115-b may be different from a path or channel between the base station 105-a and the UE 115-a. For example, a path or channel between the UE 115-b and the base station 105-a may include the RIS 225 while a path or channel between the UE 115-a and the base station 105-a may be direct. Due to an existence of different paths or channels, an initial access procedure performed by the base station 105-a and the UE 115-a may be different from an initial access procedure performed by the base station 105-a and the UE 115-b. For example, the base station 105-a and the UE 115-a or the UE 115-b may differentiate an SSB received by the UE 115-a and an SSB received by the UE 115-b as part of one or more initial access procedures.

In some examples, the base station 105-a may transmit SSBs using frequency positions defined by multiple synchronization raster grids. For example, the base station 105-a may transmit SSBs at frequency positions defined by a first synchronization raster grid for use by the UE 115-a and may transmit SSBs at frequency positions defined by a second synchronization raster grid for use by the UE 115-b. In some implementations, the first synchronization raster grid and the second synchronization raster grid may be different, for example, non-overlapping such that a frequency position used in the first synchronization raster grid is not used in the second synchronization raster grid. Although described with reference to the UE 115-a and the UE 115-b herein, SSBs transmitted using the first and second synchronization raster grids may not be unique to the UE 115-a or the UE 115-b, but rather may be received by any number of UEs 115 using a channel similar to one of the channels used by the UE 115-a or the UE 115-b. In some implementations, the base station 105-a may send an indication to the UE 115-a or the UE 115-b indicating a synchronization raster grid to monitor for SSBs. By transmitting SSBs using two synchronization raster grids, the base station 105-a may enable the UE 115-a and the UE 115-b to determine whether a connection established with the base station 105-a uses the RIS 225 and to receive one or more SSBs that may include synchronization and system information, among other advantages.

In some examples, the base station 105-a may transmit two types of SSBs. For examples, the base station 105-a may transmit SSBs of a first type for use by the UE 115-a and may transmit SSBs of a second type for use by the UE 115-b. In some implementations, the base station 105-a, the UE 115-a, or the UE 115-b may differentiate the first type of SSB from the second type by, for example, a location (e.g., in a time location, in a frequency location) or ordering of synchronization of reference signals associated with SSBs.

In some implementations, the base station 105-a may send a message (e.g., a message that may include a master information block (MIB)) to the UE 115 a or the UE 115 b (or both) indicating a type of SSB to use. For example, the base station 105-a may transmit an indication in a MIB where one value (e.g., a bit value of 0) indicates one type of SSB (e.g., a first type) and a different value (e.g., a bit value of 1) indicates another other type of SSB (e.g., a second type). Additionally or alternatively to other techniques described herein, the UE 115-a or the UE 115-b (or both) may differentiate the types of SSB or may select a type of SSB to use based on receiving the indication. In some implementations, the indication may include any number of bits corresponding to a number of types of SSBs (e.g., may indicate one, two, or more types of SSBs).

Although described with reference to the UE 115-a and the UE 115-b, the two types of SSBs may not be unique to the UE 115-a or the UE 115-b, but rather may be used by any number of UEs 115 using a path or a channel similar to one of the channels used by the UE 115-a or the UE 115-b (or both). By transmitting two types of SSBs, the base station 105-a may enable the UE 115-a or the UE 115-b to determine whether a connection established with the base station 105-a uses the RIS 225 and to receive one or more SSBs that may include synchronization and system information, among other advantages. Implementing one or more aspects of the present disclosure may enable the wireless communications system 200 to support both connections between base stations 105 and UEs 115 that support using the RIS 225 and connections between base stations 105 and UEs 115 that do not support using the RIS 225.

In some examples, the base station 105-a may use beam sweeping techniques to identify a beam for communication between the base station and the UEs 115. With respect to the UE 115-b, during beam-sweeping, the base station 105-a may transmit a set of reference signals associated with one or more beams (e.g., beams 205-a and 205-b) directed toward the RIS 225, and the RIS 225 may perform beam sweeping (e.g., the RIS 225 may reflect beams 210-b and 210-a to the UE 115-b). The UE 115-b may provide feedback to the base station 105-a indicating the strongest beam, and the base station 105-a may configure the beam associated with the base station 105-a and the beam associated with the RIS 225 for communications with the UE 115-b according to the UE feedback. The feedback may not indicate, however, whether the strongest beam reported by the UE 115-b was received by the UE 115-b directly from the base station 105-a or via the RIS 225.

In some examples, the base station 105-a may configure the UE 115-b with a variance threshold. The base station may transmit the reference signals associated with one or more beams (e.g., beams 205-a and 205-b) directed toward the RIS 225. The UE 115-b may compute a variance of the received power of the reference signals transmitted by the base station 105-a. If the variance of the received power of the reference signals is less than the variance threshold, the UE 115-b may indicate to the base station 105-a that the UE 115-b may communicate with the base station 105-a without using the RIS 225 (e.g., the blockage 220 may not affect or block a beam between the UE 115-b and the base station 105-a). If the variance of the received power of the reference signals is greater that the variance threshold, the UE 115-b may indicate to the base station 105-a to use the RIS 225 for communications with the UE 115-b.

In some examples, the base station 105-a may configure a reference beam (e.g., a probe beam), which may be one of the beams 205. The base station 105-a may transmit a set of reference signals associated with one or more beams 205 directed toward the RIS 225 and a probe reference signal corresponding to the probe beam directed toward the RIS 225. The base station 105-a may indicate to the UE 115-b and the RIS 225 which reference signal corresponds to the probe beam. The base station 105-a may configure the RIS 225 to operate in a reflecting mode for the set of reference signals and to operate in a non-reflecting mode (e.g., in a transparent mode or a scattering mode) for the probe reference signal. The base station 105-a may also indicate a received power difference threshold to the UE 115-b. The UE 115-b may compare the respective received power difference between each of the set of reference signals and the probe reference signal to the received power difference threshold. If the received power difference between each of the set of reference signals and the probe reference signal is less than the configured received power difference threshold, the UE 115-b may report the probe reference signal to the base station 105-a as being associated with the best beam, and the UE 115-b and the base station 105-a may communicate without the use of the RIS 225. If the received power difference between any of the set of reference signals and the probe reference signal exceeds the configured received power difference threshold, the UE 115-b may report one of the set of reference signals as being associated with the best beam. The UE 115-b and the base station 105-a may communicate using the RIS 225 based on the reported strongest beam.

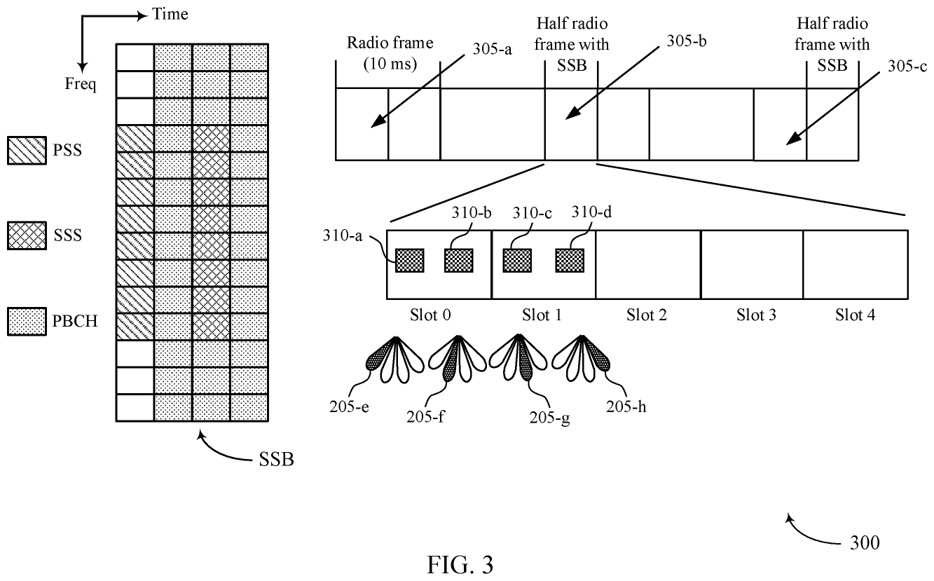

FIG. 3 illustrates an example of a resource mapping scheme 300 that supports methods for usage of a RIS in wireless communications in accordance with aspects of the present disclosure. In some examples, the resource mapping scheme 300 may be implemented by or may implement aspects of the wireless communications system 100 or 200.

A UE 115 as described herein may acquire downlink synchronization and system information based on an SSB. As shown, a base station 105 as described herein may periodically transmit SSBs (e.g., SSB 310-a, SSB 310-b, SSB-310-c, and SSB 310-d). For example, in the example resource mapping scheme 300, in the half radio frames 305-a, 305-b, and 305-c, a base station 105 may transmit SSB 310-a and SSB 310-b in slot 0 and the base station 105 may transmit SSB 310-c and SSB 310-d in slot 2.

As illustrated in FIG. 3, the SSBs 310 may correspond to a first type of SSB (e.g., a Type 0 SSB). In the SSBs 310, a primary synchronization signal (PSS) may be mapped to resource elements located earlier in time than resource elements associated with a PBCH demodulation reference signal (DMRS), a secondary synchronization signal (SSS), etc.

The base station 105 may transmit SSB 310-a, SSB 310-b, SSB-310-c, and SSB 310-d using different downlink beams. For example, the base station 105 may transmit SSB 310-a via beam 205-e, SSB 310-b via beam 205-f, SSB 310-c via beam 205-g, and SSB 310-d via beam 205-h. A UE 115 located in the direction of a particular downlink beam may receive only one of the transmitted SSBs 310. The UE 115 may be unaware of the other SSBs transmitted by the base station.

In some examples, a base station 105 may transmit SSBs on different beams using time division multiplexing. In some examples, a base station 105 may transmit SSBs on multiple frequency locations (e.g., using synchronization rasters).

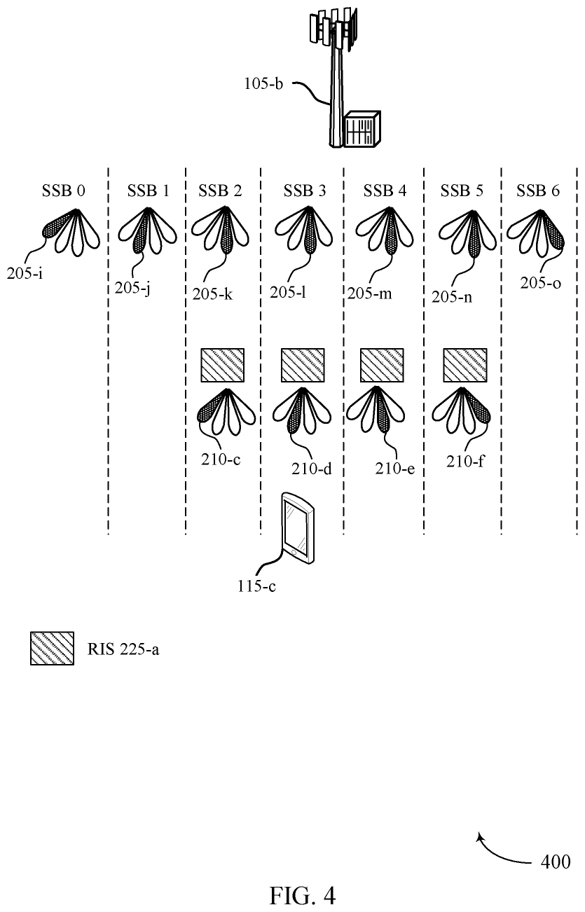

FIG. 4 illustrates an example of a beam sweeping scheme 400 that supports methods for usage of a RIS in wireless communications in accordance with aspects of the present disclosure. In some examples, the beam sweeping scheme 400 may be implemented by or may implement aspects of the wireless communications system 100 or 200. The beam sweeping scheme 400 may include a UE 115-c which may be an example of a UE 115 as described herein. The beam sweeping scheme 400 may also include a base station 105-b which may be an example of the base station 105 as described herein. The beam sweeping scheme 400 may also include a RIS 225-a which may be an example of a RIS 225 as described herein.

The base station 105-b may repeat a set of beams 205 towards a RIS 225-a (e.g., the base station 105-b may transmit a set of SSBs or reference signals associated with the beams 205). For example, the base station 105-b may transmit a first SSB (SSB 0) via beam 205-i, a second SSB (SSB 1) via beam 205-j, a third SSB (SSB 2) via beam 205-k, a fourth SSB (SSB 3) via beam 205-l, a fifth SSB (SSB 4) via beam 205-m, a sixth SSB (SSB 5) via beam 205-n, and a seventh SSB (SSB 6) via beam 205-o. Beam 205-k, beam 205-l, beam 205-m, and beam 205-n may be directed towards the RIS 225-a. The RIS 225-a may reflect beam 205-k, beam 205-l, beam 205-m, and beam 205-n toward a UE 115-c via beam 210-c, beam 210-d, beam 210-e, and beam 210-f, respectively.

The UE 115-c may measure the received power of the SSBs received over the beams 205 and 210, and report the strongest beam to the base station 105-b. For example, the UE 115-c may report the SSB with the highest received power at the UE 115-c. The base station 105-b may configure the beams 205 and 210 for communications with the UE 115-c based on the UE feedback. In some examples, however, the feedback may not indicate, however, whether the UE 115-c received the SSB directly from the base station 105-b via a beam 205 or via the RIS 225-a via a reflected beam 210. For example, the UE 115-c may report SSB 3 as having the highest received power, but the base station 105-b may be unaware of whether the UE 115-c received SSB 3 via the beam 205-l or via the reflected beam 210-d.

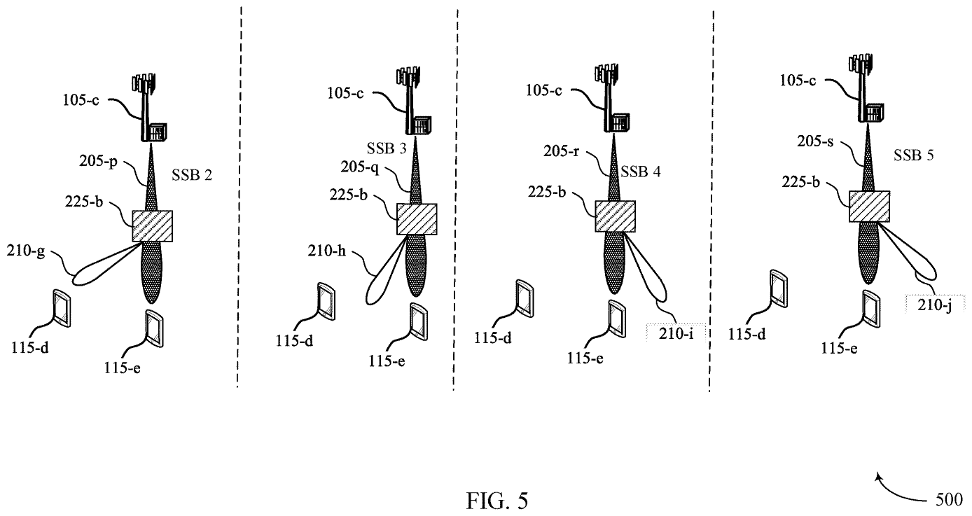

FIG. 5 illustrates an example of a beam sweeping scheme 500 that supports methods for usage of a RIS in wireless communications in accordance with aspects of the present disclosure. In some examples, the beam sweeping scheme 500 may be implemented by or may implement aspects of the wireless communications system 100 or 200. The beam sweeping scheme 500 may include a UE 115-d and a UE 115-e which may be examples of a UE 115 as described herein. The beam sweeping scheme 500 may also include a base station 105-c which may be an example of the base station 105 as described herein. The beam sweeping scheme 500 may also include a RIS 225-b which may be an example of a RIS 225 as described herein.

As shown, the base station 105-c may transmit SSBs over repeated beams. For example, the base station may transmit SSB 2 over beam 205-p, SSB 3 over beam 205-q, SSB 4 over beam 205-r, and SSB 4 over beam 205-s. The RIS 225-b may reflect beam 205-p, beam 205-q, beam 205-r, and beam 205-s using beam 210-g, beam 210-h, beam 210-i, and beam 210-j, respectively If a UE 115 is connected directly to the base station 105-c, the UE 115 may measure a similar reference signal received power (RSRP) across the repeated beams 205. For example, the UE 115-e may measure a high RSRP for each of SSB 2, SSB 3, and SSB 4, and SSB 5 because the UE 115-a is in the direction of the beams 205-p, 205-q, 205-r, and 205-s.

If a UE 115 is connected to the base station 105-c via the RIS 225-b, then the UE may measure a high variance of the RSRP across the repeated beams 205. For example, the UE 115-d may measure a high RSRP for SSB 2, a low RSRP for SSB 3, and a very low RSRP for SSB 4 and SSB 5.

Accordingly, a UE 115 may compute the variance of the RSRP across the beams 205 which are transmitted towards the RIS 225-b. If the variance is smaller than a threshold, which may be configured by the base station 105-c, then the UE 115 may report feedback information to the base station 105-c indicating that the UE 115 may communicate with the base station 105-c without the RIS 225-b. If the variance is above the threshold, then the UE 115 may report feedback information to the base station 105-c indicating that the UE 115 should communicate with the base station 105-c via the RIS 225-b. In some examples, the base station 105-c may inform the UE 115 which SSB indices are repeated towards the RIS 225-b (e.g., so that the UE 115 may monitor for the indicated SSB indices and measure the variance across the repeated SSBs).

In some examples, the UE 115 may report the feedback information via a random access channel (RACH) message, for example via msg3 with a single bit or via msg1 by transmitting the feedback information in a specific RACH occasion or a specific RACH preamble.

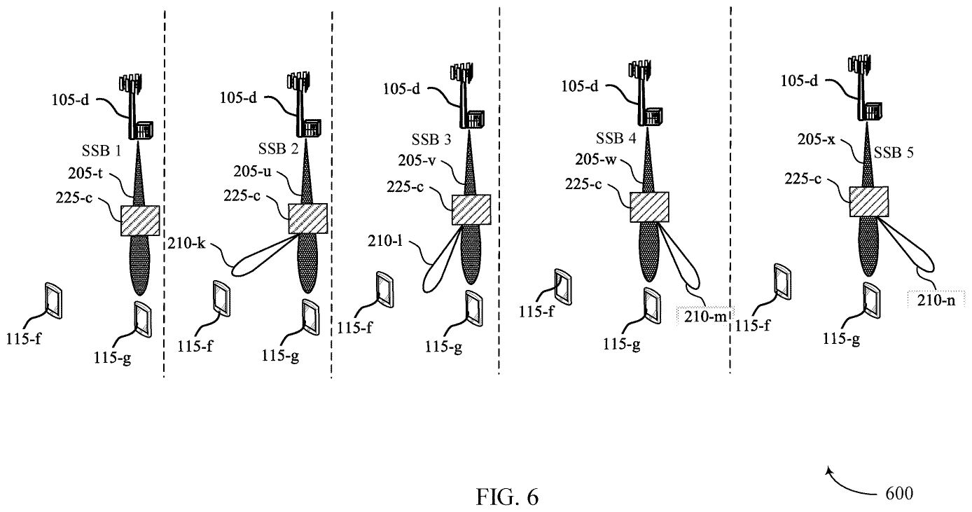

FIG. 6 illustrates an example of a beam sweeping scheme 600 that supports methods for usage of a RIS in wireless communications in accordance with aspects of the present disclosure. In some examples, the beam sweeping scheme 600 may be implemented by or may implement aspects of the wireless communications system 100 or 200. The beam sweeping scheme 600 may include a UE 115-f and a UE 115-g which may be examples of a UE 115 as described herein. The beam sweeping scheme 600 may also include a base station 105-d which may be an example of the base station 105 as described herein. The beam sweeping scheme 500 may also include a RIS 225-c which may be an example of a RIS 225 as described herein.

The base station 105-d may control the RIS 225-c to turn off (e.g., to operate in a scattering mode or a transparent mode) for a reference beam 205-t. In some examples, the reference beam 205-t may be the first beam or the last beam in a set of beams 205 repeated towards the RIS 225-c. For example, the reference beam 205-t may be associated with a lowest index or a highest index of a set of SSBs repeated towards the RIS 225-c. The base station 105-d may indicate to the UEs 115-f and 115-g and the RIS 225-c that the beam 205-t is the reference beam (e.g., the base station 105-d may indicate that SSB 1 is a reference transmission). The base station 105-d may control the RIS 225-c to operating in a non-reflecting for the reference beam 205-t and to operate in a reflecting mode for the beams 205-u, 205-v, 205-w, and 205-x.

The UE 115-f or 115-g may measure and compare the RSRPs across the repeated beams 205-u, 205-v, 205-w, and 205-x to the RSRP of the reference beam 205-t. For example, the UE 115-f or 115-g may measure the RSRPs associated with SSB 2, SSB 3, SSB 4, and SSB5 and compare the highest RSRP of the group to the RSRP of SSB 1. If the difference between the highest RSRP of the group to the RSRP of SSB 1 (the reference transmission) is less than a threshold, the UE 115-f or 115-g may determine that the reference beam 205-t is the best beam. For example, UE 115-g may measure a high RSRP for each of beams associated with SSB 1, SSB 2, SSB 3, SSB 4, and SSB 5 as the UE 115-g is in the direction of the beams associated beams 205-t, 205-u, 205-v, 205-w, and 205-x. Accordingly, the UE 115-g may determine and report to the base station 105-d that the reference beam 205-t (e.g., the beam associated with SSB 1) is the best beam.

If the difference between the highest RSRP of the group to the RSRP of SSB 1 (the reference transmission) is less than a threshold, the UE 115-f or 115-g may determine that the beam associated with the SSB that had the highest RSRP is the best beam. For example, the UE 115-f may measure a very low RSRP for the reference SSB 1, a high RSRP for SSB 2, a low RSRP for SSB 3, and a very low RSRP for SSB 4 and SSB 5. Accordingly, the UE 115-f may determine and report to the base station 105-d that the beam associated with SSB 2 is the best beam. Based on the feedback, the base station 105-d may configure the RIS 225-c for communications with the UE 115-f via the beams 205-u and 210-k.

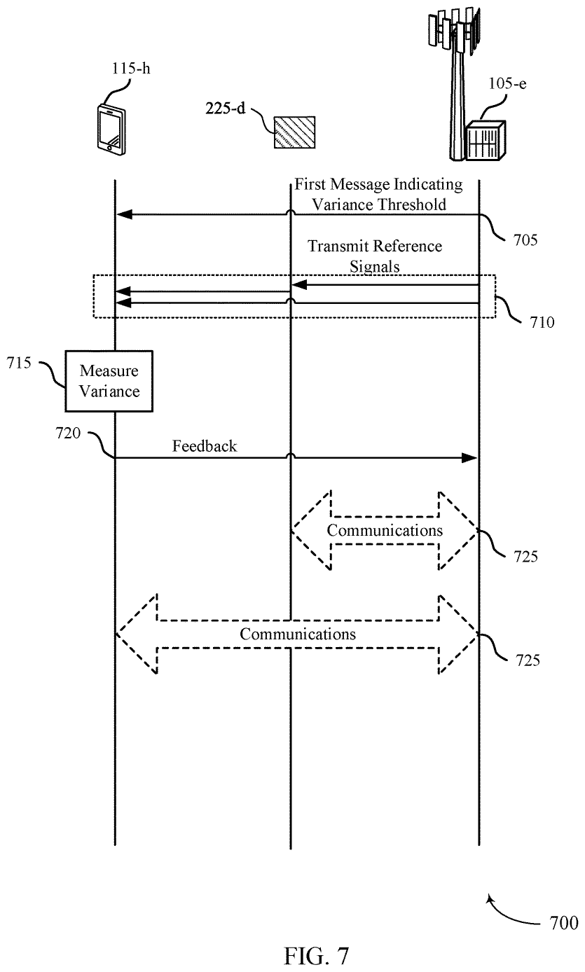

FIG. 7 illustrates an example of a process flow 700 that supports methods for usage of a RIS in wireless communications in accordance with aspects of the present disclosure. In some examples, the process flow 700 may be implemented by or may implement aspects of the wireless communications system 100 or 200 or the beam sweeping scheme 500. The process flow 700 may include a UE 115-h which may be an example of a UE 115 as described herein. The process flow 700 may also include a base station 105-e which may be an example of the base station 105 as described herein. The process flow 700 may also include a RIS 225-d which may be an example of a RIS 225 as described herein. In the following description of the process flow 700, the operations between the base station 105-e, the UE 115-h, and the RIS 225-d may be transmitted in a different order than the example order shown, or the operations performed by the base station 105-e, the UE 115-h, and the RIS 225-d may be performed in different orders or at different times. Some operations may also be omitted from the process flow 700, and other operations may be added to the process flow 700.

At 705, the base station 105-e may transmit, to the UE 115-h, a first message that indicates a variance threshold associated with the measurement of one or more reference signals by the UE 115-h. In some examples, the one or more reference signals may be SSBs. In some examples, the base station 105-e may also transmit a message to the UE 115-h indicating a set of SSB indices, and each of the reference signals may be a respective SSB associated with a respective SSB index. In some examples, the base station 105-e may also transmit, to the UE 115-h, a raster grid including frequency positions associated with the RIS 225-d.

At 710, the base station 105-e may transmit, to the UE 115-h, a first reference signal and a second reference signal.

At 715, the UE 115-h may measure a variance associated with the first and second reference signals. For example, the UE 115-h may measure a variance of the reference signal received power of the first reference signal and the second reference signal. In some examples, where the reference signals are SSBs, the UE 115-h may monitor one or more resource elements for the respective SSBs based on a received raster grid. The UE may receive the first and second reference signals based on monitoring the one or more resource elements.

At 720, the UE 115-h may transmit, to the base station 105-e, a feedback message associated with control of the RIS 225-d based on the measured variance associated with the first and second reference signals. In some examples, the UE 115-h may transmit an indication to disable the RIS 225-d based on the measured variance associated with the first and second reference signals not satisfying the variance threshold. In some examples, the UE 115-h may transmit an indication to enable the RIS 225-d based on the measured variance associated with the first and second reference signals satisfying the variance threshold. In some examples, the UE 115-h may transmit the feedback message via a RACH message.

At 725, the base station 105-e may communicate with the UE 115-h based on the feedback message received at 720. For example, the base station 105-e may transmit control signaling to the RIS 225-d to disable the RIS 225-d for communications between the base station 105-e and the UE 115-h if the base station 105-e received the indication to disable the RIS 225-d based on the measured variance associated with the first and second reference signals not satisfying the variance threshold. The base station 105-e and the UE 115-h may accordingly communicate without using the RIS 225-d. As another example, the base station 105-e may transmit control signaling to the RIS 225-d to enable the RIS 225-d for communications between the base station 105-e and the UE 115-h if the base station 105-e received the indication to enable the RIS 225-d based on the measured variance associated with the first and second reference signals satisfying the variance threshold. The base station 105-e and the UE 115-h may accordingly communicate via the RIS 225-d.

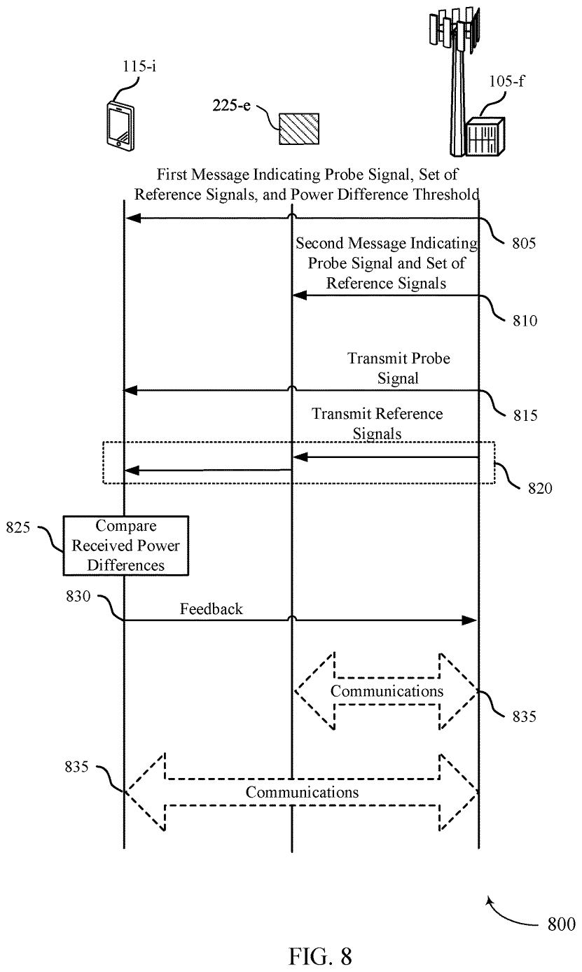

FIG. 8 illustrates an example of a process flow 800 that supports methods for usage of a RIS in wireless communications in accordance with aspects of the present disclosure. In some examples, the process flow 800 may be implemented by or may implement aspects of the wireless communications system 100 or 200 or the beam sweeping scheme 600. The process flow 800 may include a UE 115-i which may be an example of a UE 115 as described herein. The process flow 700 may also include a base station 105-f which may be an example of the base station 105 as described herein. The process flow 700 may also include a RIS 225-e which may be an example of a RIS 225 as described herein. In the following description of the process flow 800, the operations between the base station 105-f, the UE 115-i, and the RIS 225-e may be transmitted in a different order than the example order shown, or the operations performed by the base station 105-f, the UE 115-i, and the RIS 225-e may be performed in different orders or at different times. Some operations may also be omitted from the process flow 800, and other operations may be added to the process flow 800.

At 805, the base station 105-f may transmit, to the UE 115-i, a first message that indicates one or more reference signals associated with a beam directed toward a RIS 225-e, a probe reference signal, and a received power difference threshold. In some examples, the one or more reference signals may be SSBs. In some examples, the base station 105-f may also transmit a message to the UE 115-i and the RIS 225-e indicating a set of SSB indices, and each of the reference signals may be a respective SSB associated with a respective SSB index. In some examples, the probe reference signal may be associated with the lowest index or the highest index of the SSB indices. In some examples, the base station 105-f may also transmit, to the UE 115-i, a raster grid including frequency positions associated with the RIS 225-e.

At 810, the base station 105-f may transmit, to the RIS 225-e, a second message indicating to operate in a first mode to reflect the one or more reference signals and to operate in a second mode to refrain from reflecting the probe reference signal. In some examples, the first mode is a reflecting mode. In some examples, the second mode is a scattering mode or a transparent mode.

At 815 the base station 105-f may transmit the probe reference signal, and the RIS 225-e may refrain from reflecting the probe reference signal. At 820, the base station 105-f may transmit a first reference signal and a second reference signal of the one or more reference signals and the RIS 225-e may reflect the first and second reference signals.

At 825, the UE 115-i may measure the received power of the probe reference signal and the first and second reference signals. The UE 115-i may determine a first received power difference between the first reference signal and the probe reference signal and a second received power difference between the second reference signal and the probe reference signal. The UE 115-i may compare the first power difference to received power difference threshold and the second power difference to the received power difference threshold. In some examples, where the reference signals are SSBs, the UE 115-i may monitor one or more resource elements for the respective SSBs based on a received raster grid. The UE 115-i may receive the first and second reference signals based on monitoring the one or more resource elements.

At 830, the UE 115-i may transmit, to the base station 105-f, a feedback message indicating a selected reference signal based on the first comparison of the first power difference to received power difference threshold and the second power difference to the received power difference threshold. In some examples, the selected reference signal may indicate a best beam for communications between the UE 115-i and the base station 105-f. In some examples, the feedback message may indicate that the probe reference signal is the selected reference signal based on the first received power difference and the second received power difference not satisfying the received power difference threshold. In some examples, the feedback message may indicate that one of the first reference signal or the second reference signal is the selected reference signal based on one of the first received power difference or the second received power difference satisfying the received power difference threshold. In some examples, the UE 115-i may transmit the feedback message via a RACH message.

At 835, the base station 105-fmay communicate with the UE 115-i based on the feedback message received at 830. For example, if the UE 115-i reported in the feedback message that the probe reference signal is associated with the best beam, the base station 105-f may communicate with the UE 115-i via the beam associated with the probe reference signal without using the RIS 225-e. As another example, if the UE 115-i reported in the feedback message that either the first reference signal or the second reference signal is associated with the best beam, then the base station 105-f may communicate with the UE 115-i via the beam associated with the indicated first or second reference signal via the RIS 225-e.

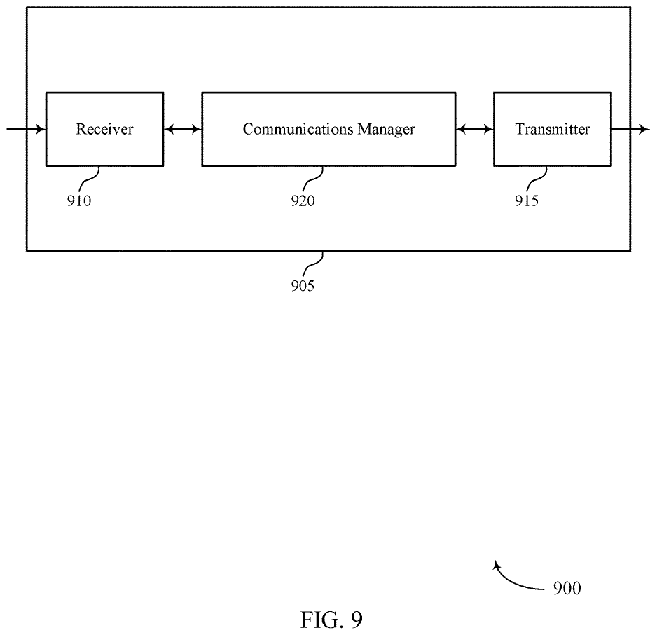

FIG. 9 shows a block diagram 900 of a device 905 that supports methods for usage of a RIS in wireless communications in accordance with aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to methods for usage of a RIS in wireless communications).

Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to methods for usage of a RIS in wireless communications). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of methods for usage of a RIS in wireless communications as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a UE in accordance with examples as disclosed herein. For example, the communications manager 920 may be configured as or otherwise support a means for receiving a first message that indicates a variance threshold associated with measurement of one or more reference signals by the UE. The communications manager 920 may be configured as or otherwise support a means for receiving a first reference signal and a second reference signal of the one or more reference signals, where both the first reference signal and the second reference signal are associated with a beam directed toward a RIS. The communications manager 920 may be configured as or otherwise support a means for measuring a variance associated with the first and second reference signals. The communications manager 920 may be configured as or otherwise support a means for transmitting a second message associated with control of the RIS based on the measured variance associated with the first and second reference signals and the variance threshold.

Additionally or alternatively, the communications manager 920 may support wireless communications at a UE in accordance with examples as disclosed herein. For example, the communications manager 920 may be configured as or otherwise support a means for receiving a first message that indicates one or more reference signals associated with a beam directed toward a RIS, a probe reference signal, and a received power difference threshold. The communications manager 920 may be configured as or otherwise support a means for receiving the probe reference signal and a first reference signal and a second reference signal of the one or more reference signals. The communications manager 920 may be configured as or otherwise support a means for transmitting, to a base station, a second message indicating a selected reference signal based on a first comparison of a first received power difference between the first reference signal and the probe reference signal to the received power difference threshold and a second comparison of a second received power difference between the second reference signal and the probe reference signal to the received power difference threshold.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for more efficient utilization of communication resources by using techniques for determining when to use a RIS for communications between a UE and a base station.

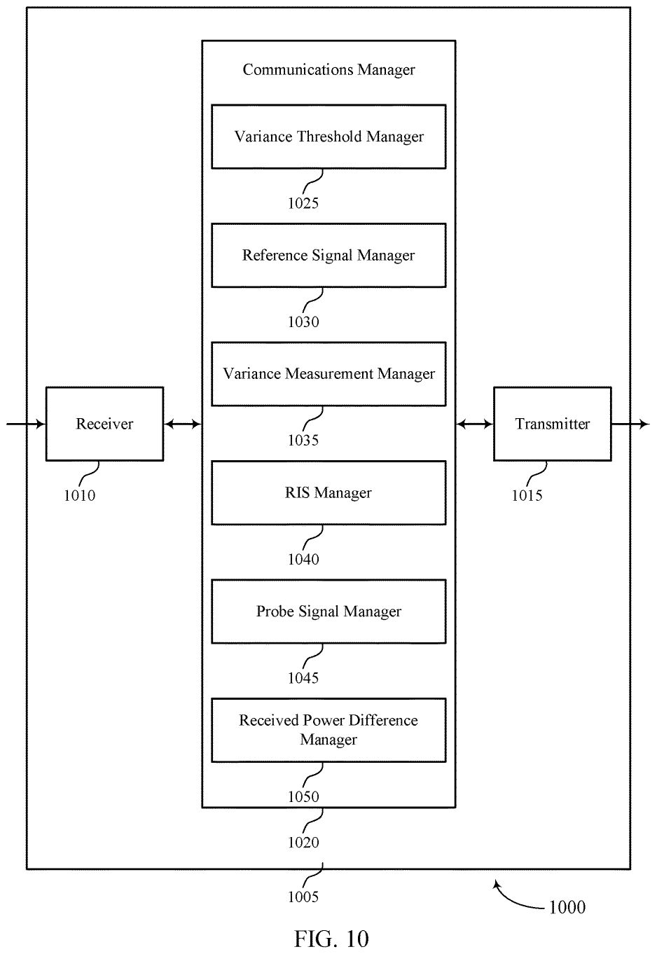

FIG. 10 shows a block diagram 1000 of a device 1005 that supports methods for usage of a RIS in wireless communications in accordance with aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to methods for usage of a RIS in wireless communications). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to methods for usage of a RIS in wireless communications). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of methods for usage of a RIS in wireless communications as described herein. For example, the communications manager 1020 may include a variance threshold manager 1025, a reference signal manager 1030, a variance measurement manager 1035, a RIS manager 1040, a probe signal manager 1045, a received power difference manager 1050, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a UE in accordance with examples as disclosed herein. The variance threshold manager 1025 may be configured as or otherwise support a means for receiving a first message that indicates a variance threshold associated with measurement of one or more reference signals by the UE. The reference signal manager 1030 may be configured as or otherwise support a means for receiving a first reference signal and a second reference signal of the one or more reference signals, where both the first reference signal and the second reference signal are associated with a beam directed toward a RIS. The variance measurement manager 1035 may be configured as or otherwise support a means for measuring a variance associated with the first and second reference signals.

The RIS manager 1040 may be configured as or otherwise support a means for transmitting a second message associated with control of the RIS based on the measured variance associated with the first and second reference signals and the variance threshold.

Additionally or alternatively, the communications manager 1020 may support wireless communications at a UE in accordance with examples as disclosed herein. The probe signal manager 1045 may be configured as or otherwise support a means for receiving a first message that indicates one or more reference signals associated with a beam directed toward a RIS, a probe reference signal, and a received power difference threshold. The reference signal manager 1030 may be configured as or otherwise support a means for receiving the probe reference signal and a first reference signal and a second reference signal of the one or more reference signals. The received power difference manager 1050 may be configured as or otherwise support a means for transmitting, to a base station, a second message indicating a selected reference signal based on a first comparison of a first received power difference between the first reference signal and the probe reference signal to the received power difference threshold and a second comparison of a second received power difference between the second reference signal and the probe reference signal to the received power difference threshold.

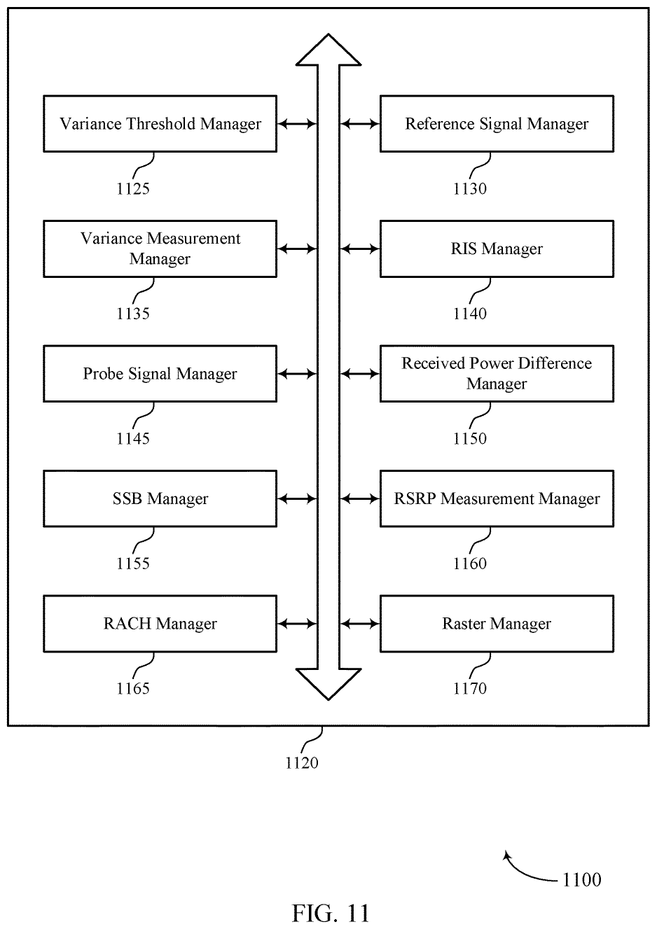

FIG. 11 shows a block diagram 1100 of a communications manager 1120 that supports methods for usage of a RIS in wireless communications in accordance with aspects of the present disclosure. The communications manager 1120 may be an example of aspects of a communications manager 920, a communications manager 1020, or both, as described herein. The communications manager 1120, or various components thereof, may be an example of means for performing various aspects of methods for usage of a RIS in wireless communications as described herein. For example, the communications manager 1120 may include a variance threshold manager 1125, a reference signal manager 1130, a variance measurement manager 1135, a RIS manager 1140, a probe signal manager 1145, a received power difference manager 1150, an SSB manager 1155, an RSRP measurement manager 1160, a RACH manager 1165, a raster manager 1170, or any combination thereof. Each of these components may communicate, directly or indirectly, with one another (e.g., via one or more buses).

The communications manager 1120 may support wireless communications at a UE in accordance with examples as disclosed herein. The variance threshold manager 1125 may be configured as or otherwise support a means for receiving a first message that indicates a variance threshold associated with measurement of one or more reference signals by the UE. The reference signal manager 1130 may be configured as or otherwise support a means for receiving a first reference signal and a second reference signal of the one or more reference signals, where both the first reference signal and the second reference signal are associated with a beam directed toward a RIS. The variance measurement manager 1135 may be configured as or otherwise support a means for measuring a variance associated with the first and second reference signals. The RIS manager 1140 may be configured as or otherwise support a means for transmitting a second message associated with control of the RIS based on the measured variance associated with the first and second reference signals and the variance threshold.

In some examples, the SSB manager 1155 may be configured as or otherwise support a means for receiving a third message indicating a set of multiple synchronization signal block indices, where each of the one or more reference signals includes a respective synchronization signal block signal associated with a respective synchronization signal block index.

In some examples, to support receiving the third message, the raster manager 1170 may be configured as or otherwise support a means for receiving a raster grid including frequency positions associated with the RIS.

In some examples, the reference signal manager 1130 may be configured as or otherwise support a means for monitoring one or more resource elements for the respective synchronization signal block signals based on the raster grid, where receiving the first reference signal and the second reference signal is based on the monitoring.

In some examples, to support measuring the variance, the RSRP measurement manager 1160 may be configured as or otherwise support a means for measuring a reference signal received power variance associated with the first and second reference signals.

In some examples, to support transmitting the second message, the RACH manager 1165 may be configured as or otherwise support a means for transmitting the second message in a random access procedure transmission.

In some examples, to support transmitting the second message, the RIS manager 1140 may be configured as or otherwise support a means for transmitting a first indication to disable the RIS for communications with the UE based on the measured variance associated with the first and second reference signals not satisfying the variance threshold, or transmitting a second indication to enable the RIS for communications with the UE based on the measured variance associated with the first and second reference signals satisfying the variance threshold.

Additionally or alternatively, the communications manager 1120 may support wireless communications at a UE in accordance with examples as disclosed herein. The probe signal manager 1145 may be configured as or otherwise support a means for receiving a first message that indicates one or more reference signals associated with a beam directed toward a RIS, a probe reference signal, and a received power difference threshold. In some examples, the reference signal manager 1130 may be configured as or otherwise support a means for receiving the probe reference signal and a first reference signal and a second reference signal of the one or more reference signals. The received power difference manager 1150 may be configured as or otherwise support a means for transmitting, to a base station, a second message indicating a selected reference signal based on a first comparison of a first received power difference between the first reference signal and the probe reference signal to the received power difference threshold and a second comparison of a second received power difference between the second reference signal and the probe reference signal to the received power difference threshold.

In some examples, to support transmitting the second message, the received power difference manager 1150 may be configured as or otherwise support a means for transmitting an indication that the probe reference signal is the selected reference signal based on the first received power difference and the second received power difference not satisfying the received power difference threshold.

In some examples, to support transmitting the second message, the received power difference manager 1150 may be configured as or otherwise support a means for transmitting an indication that one of the first reference signal or the second reference signal is the selected reference signal based on one of the first received power difference or the second received power difference satisfying the received power difference threshold.

In some examples, the SSB manager 1155 may be configured as or otherwise support a means for receiving a third message indicating a set of multiple synchronization signal block indices, where each of the one or more reference signals and the probe reference signal includes a synchronization signal block signal associated with a respective synchronization signal block index.

In some examples, to support receiving the third message, the raster manager 1170 may be configured as or otherwise support a means for receiving a raster grid including frequency positions associated with the RIS.

In some examples, the reference signal manager 1130 may be configured as or otherwise support a means for monitoring one or more resource elements for the respective synchronization signal block signals based on the raster grid, where receiving the probe reference signal and the first reference signal and the second reference signal is based on the monitoring.

In some examples, the probe reference signal is associated with one of a lowest index or a highest index of the set of multiple synchronization signal block indices.

In some examples, the RSRP measurement manager 1160 may be configured as or otherwise support a means for measuring a first reference signal received power of the first reference signal, a second reference signal received power of the second reference signal, and a third reference signal received power of the probe reference signal, where the first comparison and the second comparison are based on the first reference signal received power, the second reference signal received power, and the third reference signal received power.

In some examples, to support transmitting the second message, the RACH manager 1165 may be configured as or otherwise support a means for transmitting the second message in a random access procedure transmission.

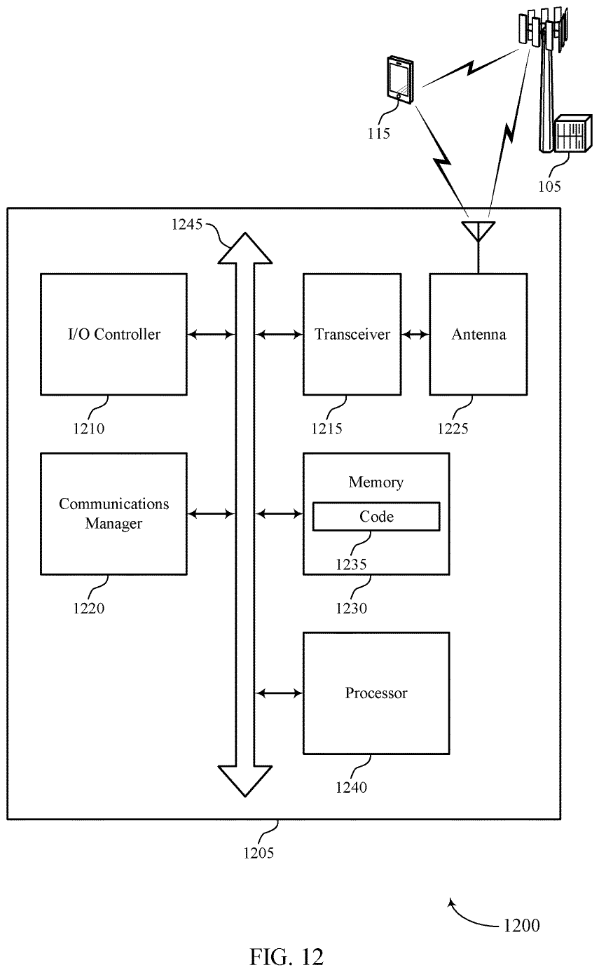

FIG. 12 shows a diagram of a system 1200 including a device 1205 that supports methods for usage of a RIS in wireless communications in accordance with aspects of the present disclosure. The device 1205 may be an example of or include the components of a device 905, a device 1005, or a UE 115 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting methods for usage of a RIS in wireless communications). For example, the device 1205 or a component of the device 1205 may include a processor 1240 and memory 1230 coupled to the processor 1240, the processor 1240 and memory 1230 configured to perform various functions described herein.

The communications manager 1220 may support wireless communications at a UE in accordance with examples as disclosed herein. For example, the communications manager 1220 may be configured as or otherwise support a means for receiving a first message that indicates a variance threshold associated with measurement of one or more reference signals by the UE. The communications manager 1220 may be configured as or otherwise support a means for receiving a first reference signal and a second reference signal of the one or more reference signals, where both the first reference signal and the second reference signal are associated with a beam directed toward a RIS. The communications manager 1220 may be configured as or otherwise support a means for measuring a variance associated with the first and second reference signals. The communications manager 1220 may be configured as or otherwise support a means for transmitting a second message associated with control of the RIS based on the measured variance associated with the first and second reference signals and the variance threshold.

Additionally or alternatively, the communications manager 1220 may support wireless communications at a UE in accordance with examples as disclosed herein. For example, the communications manager 1220 may be configured as or otherwise support a means for receiving a first message that indicates one or more reference signals associated with a beam directed toward a RIS, a probe reference signal, and a received power difference threshold. The communications manager 1220 may be configured as or otherwise support a means for receiving the probe reference signal and a first reference signal and a second reference signal of the one or more reference signals. The communications manager 1220 may be configured as or otherwise support a means for transmitting, to a base station, a second message indicating a selected reference signal based on a first comparison of a first received power difference between the first reference signal and the probe reference signal to the received power difference threshold and a second comparison of a second received power difference between the second reference signal and the probe reference signal to the received power difference threshold.

By including or configuring the communications manager 1220 in accordance with examples as described herein, the device 1205 may support techniques for improved communication reliability, more efficient utilization of communication resources, and improved coordination between devices by using techniques for determining when to use a RIS for communications between a UE and a base station.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of methods for usage of a RIS in wireless communications as described herein, or the processor 1240 and the memory 1230 may be otherwise configured to perform or support such operations.

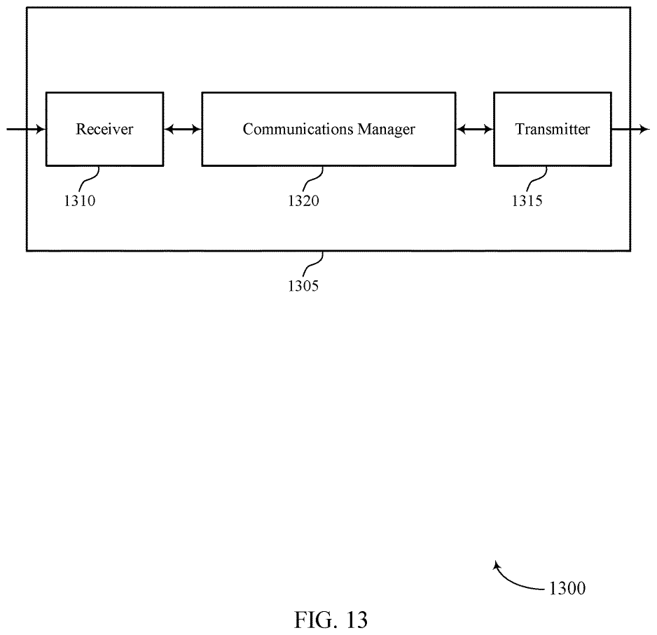

FIG. 13 shows a block diagram 1300 of a device 1305 that supports methods for usage of a RIS in wireless communications in accordance with aspects of the present disclosure. The device 1305 may be an example of aspects of a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to methods for usage of a RIS in wireless communications). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to methods for usage of a RIS in wireless communications). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations thereof or various components thereof may be examples of means for performing various aspects of methods for usage of a RIS in wireless communications as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1320 may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communications at a base station in accordance with examples as disclosed herein. For example, the communications manager 1320 may be configured as or otherwise support a means for transmitting a first message that indicates a variance threshold associated with measurement of one or more reference signals by a UE. The communications manager 1320 may be configured as or otherwise support a means for transmitting a first reference signal and a second reference signal of the one or more reference signals, where both the first reference signal and the second reference signal are associated with a beam directed toward a RIS. The communications manager 1320 may be configured as or otherwise support a means for receiving, from the UE, a second message associated with control of the RIS based on a measured variance associated with the first and second reference signals and the variance threshold.

Additionally or alternatively, the communications manager 1320 may support wireless communications at a base station in accordance with examples as disclosed herein. For example, the communications manager 1320 may be configured as or otherwise support a means for transmitting a first message that indicates one or more reference signals associated with a beam directed toward a RIS, a probe reference signal, and a received power difference threshold. The communications manager 1320 may be configured as or otherwise support a means for transmitting, to the RIS, a second message indicating to reflect the one or more reference signals and to refrain from reflecting the probe reference signal. The communications manager 1320 may be configured as or otherwise support a means for transmitting the probe reference signal and a first reference signal and a second reference signal of the one or more reference signals. The communications manager 1320 may be configured as or otherwise support a means for receiving a third message indicating a selected reference signal based on a first comparison of a first received power difference between the first reference signal and the probe reference signal to the received power difference threshold and a second comparison of a second received power difference between the second reference signal and the probe reference signal to the received power difference threshold.

By including or configuring the communications manager 1320 in accordance with examples as described herein, the device 1305 (e.g., a processor controlling or otherwise coupled to the receiver 1310, the transmitter 1315, the communications manager 1320, or a combination thereof) may support techniques for more efficient utilization of communication resources by using techniques for determining when to use a RIS for communications between a UE and a base station.

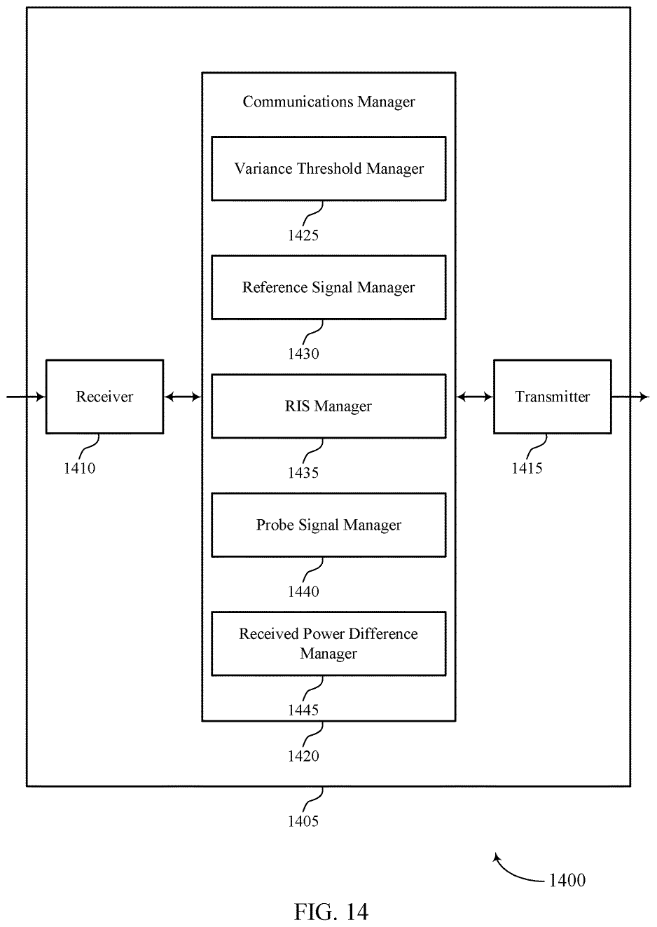

FIG. 14 shows a block diagram 1400 of a device 1405 that supports methods for usage of a RIS in wireless communications in accordance with aspects of the present disclosure. The device 1405 may be an example of aspects of a device 1305 or a base station 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to methods for usage of a RIS in wireless communications).

Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to methods for usage of a RIS in wireless communications). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of methods for usage of a RIS in wireless communications as described herein. For example, the communications manager 1420 may include a variance threshold manager 1425, a reference signal manager 1430, a RIS manager 1435, a probe signal manager 1440, a received power difference manager 1445, or any combination thereof. The communications manager 1420 may be an example of aspects of a communications manager 1320 as described herein. In some examples, the communications manager 1420, or various components thereof, may be configured to perform various operations (e.g., receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communications at a base station in accordance with examples as disclosed herein. The variance threshold manager 1425 may be configured as or otherwise support a means for transmitting a first message that indicates a variance threshold associated with measurement of one or more reference signals by a UE. The reference signal manager 1430 may be configured as or otherwise support a means for transmitting a first reference signal and a second reference signal of the one or more reference signals, where both the first reference signal and the second reference signal are associated with a beam directed toward a RIS. The RIS manager 1435 may be configured as or otherwise support a means for receiving, from the UE, a second message associated with control of the RIS based on a measured variance associated with the first and second reference signals and the variance threshold.

Additionally or alternatively, the communications manager 1420 may support wireless communications at a base station in accordance with examples as disclosed herein. The probe signal manager 1440 may be configured as or otherwise support a means for transmitting a first message that indicates one or more reference signals associated with a beam directed toward a RIS, a probe reference signal, and a received power difference threshold. The RIS manager 1435 may be configured as or otherwise support a means for transmitting, to the RIS, a second message indicating to reflect the one or more reference signals and to refrain from reflecting the probe reference signal. The reference signal manager 1430 may be configured as or otherwise support a means for transmitting the probe reference signal and a first reference signal and a second reference signal of the one or more reference signals. The received power difference manager 1445 may be configured as or otherwise support a means for receiving a third message indicating a selected reference signal based on a first comparison of a first received power difference between the first reference signal and the probe reference signal to the received power difference threshold and a second comparison of a second received power difference between the second reference signal and the probe reference signal to the received power difference threshold.

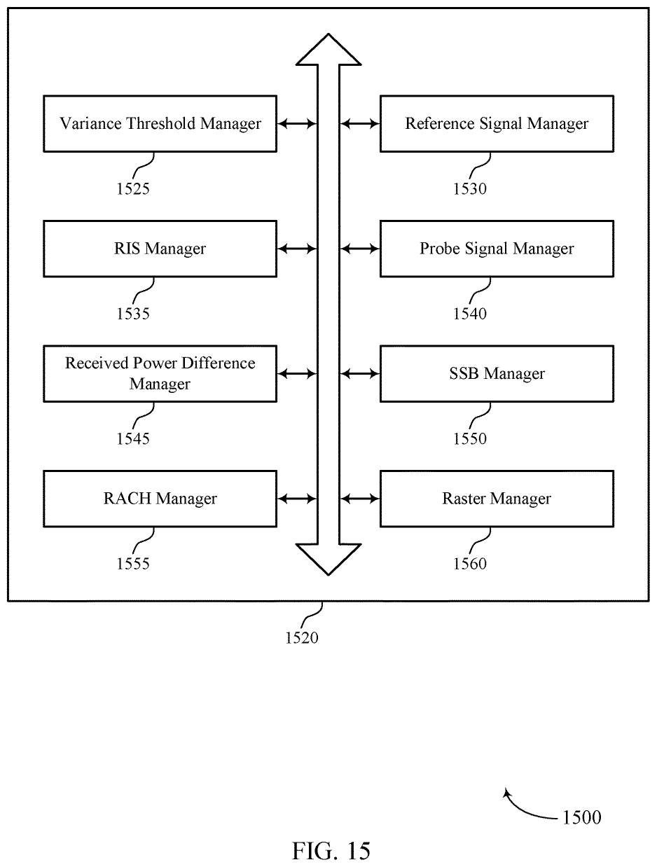

FIG. 15 shows a block diagram 1500 of a communications manager 1520 that supports methods for usage of a RIS in wireless communications in accordance with aspects of the present disclosure. The communications manager 1520 may be an example of aspects of a communications manager 1320, a communications manager 1420, or both, as described herein. The communications manager 1520, or various components thereof, may be an example of means for performing various aspects of methods for usage of a RIS in wireless communications as described herein. For example, the communications manager 1520 may include a variance threshold manager 1525, a reference signal manager 1530, a RIS manager 1535, a probe signal manager 1540, a received power difference manager 1545, an SSB manager 1550, a RACH manager 1555, a raster manager 1560, or any combination thereof. Each of these components may communicate, directly or indirectly, with one another (e.g., via one or more buses).

The communications manager 1520 may support wireless communications at a base station in accordance with examples as disclosed herein. The variance threshold manager 1525 may be configured as or otherwise support a means for transmitting a first message that indicates a variance threshold associated with measurement of one or more reference signals by a UE. The reference signal manager 1530 may be configured as or otherwise support a means for transmitting a first reference signal and a second reference signal of the one or more reference signals, where both the first reference signal and the second reference signal are associated with a beam directed toward a RIS. The RIS manager 1535 may be configured as or otherwise support a means for receiving, from the UE, a second message associated with control of the RIS based on a measured variance associated with the first and second reference signals and the variance threshold.

In some examples, the SSB manager 1550 may be configured as or otherwise support a means for transmitting a third message indicating a set of multiple synchronization signal block indices, where each of the one or more reference signals includes a respective synchronization signal block signal associated with a respective synchronization signal block index.

In some examples, to support transmitting the third message, the raster manager 1560 may be configured as or otherwise support a means for transmitting a raster grid including frequency positions associated with the RIS.

In some examples, to support receiving the second message, the RACH manager 1555 may be configured as or otherwise support a means for receiving the second message in a random access procedure transmission.

In some examples, to support receiving the second message, the RIS manager 1535 may be configured as or otherwise support a means for receiving a first indication to disable the RIS for communications with the UE based on the measured variance associated with the first and second reference signals not satisfying the variance threshold, or receiving a second indication to enable the RIS for communications with the UE based on the measured variance associated with the first and second reference signals satisfying the variance threshold.

In some examples, the RIS manager 1535 may be configured as or otherwise support a means for transmitting, to the RIS, first control signaling indicating to disable the RIS for communications with the UE based on receiving the first indication. In some examples, the RIS manager 1535 may be configured as or otherwise support a means for transmitting, to the RIS, second control signaling indicating to enable the RIS for communications with the UE based on receiving the second indication.

Additionally or alternatively, the communications manager 1520 may support wireless communications at a base station in accordance with examples as disclosed herein. The probe signal manager 1540 may be configured as or otherwise support a means for transmitting a first message that indicates one or more reference signals associated with a beam directed toward a RIS, a probe reference signal, and a received power difference threshold. In some examples, the RIS manager 1535 may be configured as or otherwise support a means for transmitting, to the RIS, a second message indicating to reflect the one or more reference signals and to refrain from reflecting the probe reference signal. In some examples, the reference signal manager 1530 may be configured as or otherwise support a means for transmitting the probe reference signal and a first reference signal and a second reference signal of the one or more reference signals. The received power difference manager 1545 may be configured as or otherwise support a means for receiving a third message indicating a selected reference signal based on a first comparison of a first received power difference between the first reference signal and the probe reference signal to the received power difference threshold and a second comparison of a second received power difference between the second reference signal and the probe reference signal to the received power difference threshold.

In some examples, to support receiving the third message, the received power difference manager 1545 may be configured as or otherwise support a means for receiving an indication that the probe reference signal is the selected reference signal based on the first received power difference and the second received power difference not satisfying the received power difference threshold.

In some examples, to support receiving the third message, the received power difference manager 1545 may be configured as or otherwise support a means for receiving an indication that one of the first reference signal or the second reference signal is the selected reference signal based on one of the first received power difference or the second received power difference satisfying the received power difference threshold.

In some examples, the SSB manager 1550 may be configured as or otherwise support a means for transmitting a fourth message indicating a set of multiple synchronization signal block indices, where each of the one or more reference signals and the probe reference signal includes a synchronization signal block signal associated with a respective synchronization signal block index.

In some examples, to support transmitting the fourth message, the raster manager 1560 may be configured as or otherwise support a means for transmitting a raster grid including frequency positions associated with the RIS.

In some examples, the probe reference signal is associated with one of a lowest index or a highest index of the set of multiple synchronization signal block indices.

In some examples, to support receiving the third message, the RACH manager 1555 may be configured as or otherwise support a means for receiving the third message in a random access procedure transmission.

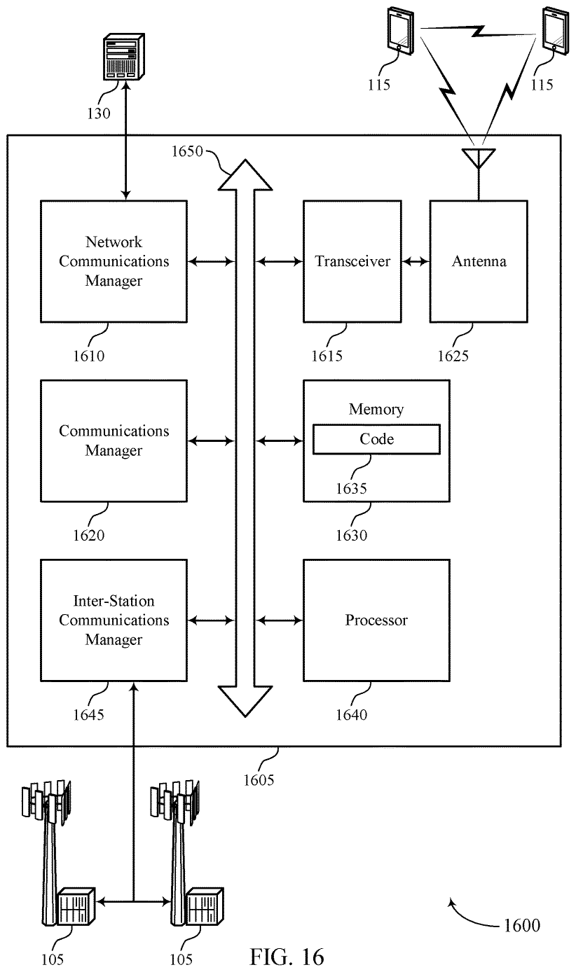

FIG. 16 shows a diagram of a system 1600 including a device 1605 that supports methods for usage of a RIS in wireless communications in accordance with aspects of the present disclosure. The device 1605 may be an example of or include the components of a device 1305, a device 1405, or a base station 105 as described herein. The device 1605 may communicate wirelessly with one or more base stations 105, UEs 115, or any combination thereof. The device 1605 may include components for bi-directional voice and data communications including components for transmitting and receiving communications, such as a communications manager 1620, a network communications manager 1610, a transceiver 1615, an antenna 1625, a memory 1630, code 1635, a processor 1640, and an inter-station communications manager 1645. These components may be in electronic communication or otherwise coupled (e.g., operatively, communicatively, functionally, electronically, electrically) via one or more buses (e.g., a bus 1650).

The network communications manager 1610 may manage communications with a core network 130 (e.g., via one or more wired backhaul links). For example, the network communications manager 1610 may manage the transfer of data communications for client devices, such as one or more UEs 115.

In some cases, the device 1605 may include a single antenna 1625. However, in some other cases the device 1605 may have more than one antenna 1625, which may be capable of concurrently transmitting or receiving multiple wireless transmissions. The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include RAM and ROM. The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (e.g., when compiled and executed) to perform functions described herein. In some cases, the memory 1630 may contain, among other things, a BIOS which may control basic hardware or software operation such as the interaction with peripheral components or devices.

The processor 1640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting methods for usage of a RIS in wireless communications). For example, the device 1605 or a component of the device 1605 may include a processor 1640 and memory 1630 coupled to the processor 1640, the processor 1640 and memory 1630 configured to perform various functions described herein.

The inter-station communications manager 1645 may manage communications with other base stations 105, and may include a controller or scheduler for controlling communications with UEs 115 in cooperation with other base stations 105. For example, the inter-station communications manager 1645 may coordinate scheduling for transmissions to UEs 115 for various interference mitigation techniques such as beamforming or joint transmission. In some examples, the inter-station communications manager 1645 may provide an X2 interface within an LTE/LTE-A wireless communications network technology to provide communication between base stations 105.

The communications manager 1620 may support wireless communications at a base station in accordance with examples as disclosed herein. For example, the communications manager 1620 may be configured as or otherwise support a means for transmitting a first message that indicates a variance threshold associated with measurement of one or more reference signals by a UE. The communications manager 1620 may be configured as or otherwise support a means for transmitting a first reference signal and a second reference signal of the one or more reference signals, where both the first reference signal and the second reference signal are associated with a beam directed toward a RIS. The communications manager 1620 may be configured as or otherwise support a means for receiving, from the UE, a second message associated with control of the RIS based on a measured variance associated with the first and second reference signals and the variance threshold.

Additionally or alternatively, the communications manager 1620 may support wireless communications at a base station in accordance with examples as disclosed herein. For example, the communications manager 1620 may be configured as or otherwise support a means for transmitting a first message that indicates one or more reference signals associated with a beam directed toward a RIS, a probe reference signal, and a received power difference threshold. The communications manager 1620 may be configured as or otherwise support a means for transmitting, to the RIS, a second message indicating to reflect the one or more reference signals and to refrain from reflecting the probe reference signal. The communications manager 1620 may be configured as or otherwise support a means for transmitting the probe reference signal and a first reference signal and a second reference signal of the one or more reference signals. The communications manager 1620 may be configured as or otherwise support a means for receiving a third message indicating a selected reference signal based on a first comparison of a first received power difference between the first reference signal and the probe reference signal to the received power difference threshold and a second comparison of a second received power difference between the second reference signal and the probe reference signal to the received power difference threshold.

By including or configuring the communications manager 1620 in accordance with examples as described herein, the device 1605 may support techniques for improved communication reliability, more efficient utilization of communication resources, and improved coordination between devices by using techniques for determining when to use a RIS for communications between a UE and a base station.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of methods for usage of a RIS in wireless communications as described herein, or the processor 1640 and the memory 1630 may be otherwise configured to perform or support such operations.

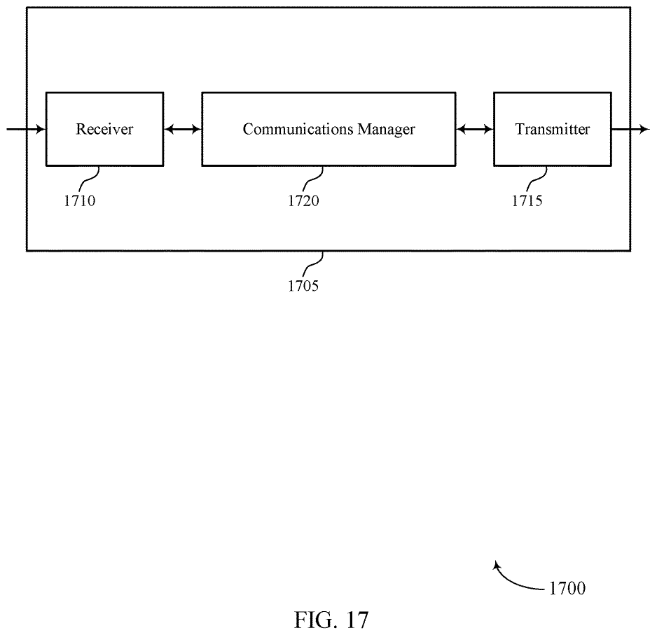

FIG. 17 shows a block diagram 1700 of a device 1705 that supports methods for usage of a RIS in wireless communications in accordance with aspects of the present disclosure. The device 1705 may be an example of aspects of a RIS 225 as described herein. The device 1705 may include a receiver 1710, a transmitter 1715, and a communications manager 1720. The device 1705 may also include a processor. Each of these components may be in communication with one another (e.g., via one or more buses).

The receiver 1710 may provide a means for receiving information such as packets, user data, control information, or any combination thereof associated with various information channels (e.g., control channels, data channels, information channels related to methods for usage of a RIS in wireless communications).

Information may be passed on to other components of the device 1705. The receiver 1710 may utilize a single antenna or a set of multiple antennas.

The transmitter 1715 may provide a means for transmitting signals generated by other components of the device 1705. For example, the transmitter 1715 may transmit information such as packets, user data, control information, or any combination thereof associated with various information channels (e.g., control channels, data channels, information channels related to methods for usage of a RIS in wireless communications). In some examples, the transmitter 1715 may be co-located with a receiver 1710 in a transceiver module. The transmitter 1715 may utilize a single antenna or a set of multiple antennas.

The communications manager 1720, the receiver 1710, the transmitter 1715, or various combinations thereof or various components thereof may be examples of means for performing various aspects of methods for usage of a RIS in wireless communications as described herein. For example, the communications manager 1720, the receiver 1710, the transmitter 1715, or various combinations or components thereof may support a method for performing one or more of the functions described herein.

In some examples, the communications manager 1720, the receiver 1710, the transmitter 1715, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1720, the receiver 1710, the transmitter 1715, or various combinations or components thereof may be implemented in code (e.g., as communications management software or firmware) executed by a processor. If implemented in code executed by a processor, the functions of the communications manager 1720, the receiver 1710, the transmitter 1715, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1720 may be configured to perform various operations (e.g., receiving, monitoring, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to receive information, transmit information, or perform various other operations as described herein.

The communications manager 1720 may support wireless communications at a RIS in accordance with examples as disclosed herein. For example, the communications manager 1720 may be configured as or otherwise support a means for receiving, from a base station, a message instructing the RIS to operate in a first mode for each of a set of multiple transmissions from the base station and to operate in a second mode for a probe transmission from the base station, where each of the set of multiple transmissions and the probe transmission are associated with a same beam direction. The communications manager 1720 may be configured as or otherwise support a means for reflecting, by the RIS operating in the first mode, the set of multiple transmissions from the base station. The communications manager 1720 may be configured as or otherwise support a means for refraining from reflecting, by the RIS operating in the second mode, the probe transmission from the base station.

By including or configuring the communications manager 1720 in accordance with examples as described herein, the device 1705 (e.g., a processor controlling or otherwise coupled to the receiver 1710, the transmitter 1715, the communications manager 1720, or a combination thereof) may support techniques for more efficient utilization of communication resources by using techniques for determining when to use a RIS for communications between a UE and a base station.

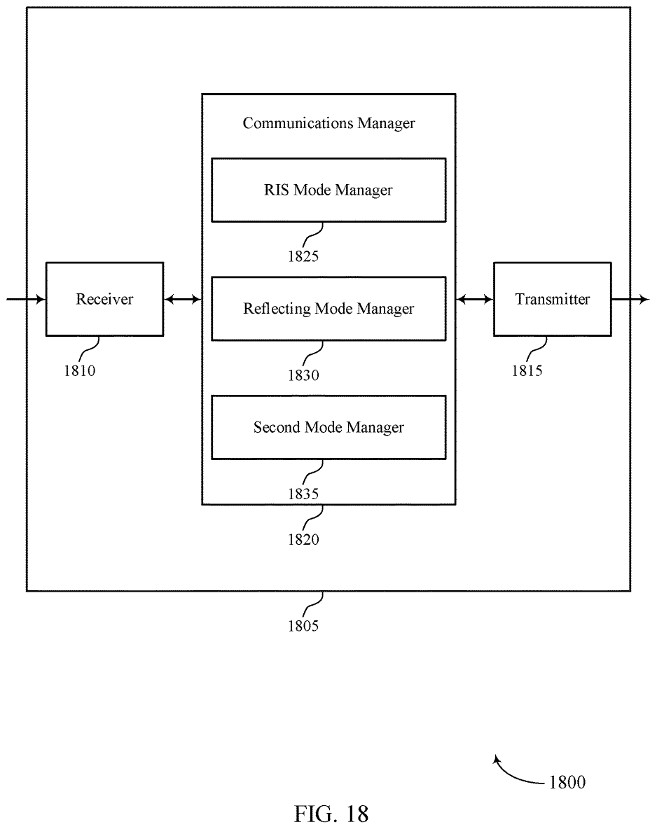

FIG. 18 shows a block diagram 1800 of a device 1805 that supports methods for usage of a RIS in wireless communications in accordance with aspects of the present disclosure. The device 1805 may be an example of aspects of a device 1705 or a RIS 225 as described herein. The device 1805 may include a receiver 1810, a transmitter 1815, and a communications manager 1820. The device 1805 may also include a processor. Each of these components may be in communication with one another (e.g., via one or more buses).

The receiver 1810 may provide a means for receiving information such as packets, user data, control information, or any combination thereof associated with various information channels (e.g., control channels, data channels, information channels related to methods for usage of a RIS in wireless communications).

Information may be passed on to other components of the device 1805. The receiver 1810 may utilize a single antenna or a set of multiple antennas.

The transmitter 1815 may provide a means for transmitting signals generated by other components of the device 1805. For example, the transmitter 1815 may transmit information such as packets, user data, control information, or any combination thereof associated with various information channels (e.g., control channels, data channels, information channels related to methods for usage of a RIS in wireless communications). In some examples, the transmitter 1815 may be co-located with a receiver 1810 in a transceiver module. The transmitter 1815 may utilize a single antenna or a set of multiple antennas.

The device 1805, or various components thereof, may be an example of means for performing various aspects of methods for usage of a RIS in wireless communications as described herein. For example, the communications manager 1820 may include a RIS mode manager 1825, a reflecting mode manager 1830, a second mode manager 1835, or any combination thereof. The communications manager 1820 may be an example of aspects of a communications manager 1720 as described herein. In some examples, the communications manager 1820, or various components thereof, may be configured to perform various operations (e.g., receiving, monitoring, transmitting) using or otherwise in cooperation with the receiver 1810, the transmitter 1815, or both. For example, the communications manager 1820 may receive information from the receiver 1810, send information to the transmitter 1815, or be integrated in combination with the receiver 1810, the transmitter 1815, or both to receive information, transmit information, or perform various other operations as described herein.

The communications manager 1820 may support wireless communications at a RIS in accordance with examples as disclosed herein. The RIS mode manager 1825 may be configured as or otherwise support a means for receiving, from a base station, a message instructing the RIS to operate in a first mode for each of a set of multiple transmissions from the base station and to operate in a second mode for a probe transmission from the base station, where each of the set of multiple transmissions and the probe transmission are associated with a same beam direction. The reflecting mode manager 1830 may be configured as or otherwise support a means for reflecting, by the RIS operating in the first mode, the set of multiple transmissions from the base station. The second mode manager 1835 may be configured as or otherwise support a means for refraining from reflecting, by the RIS operating in the second mode, the probe transmission from the base station.

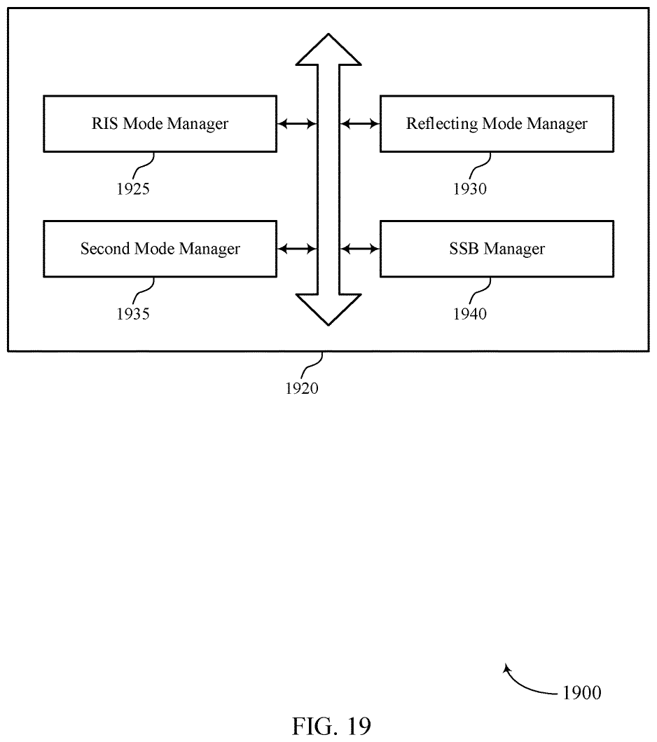

FIG. 19 shows a block diagram 1900 of a communications manager 1920 that supports methods for usage of a RIS in wireless communications in accordance with aspects of the present disclosure. The communications manager 1920 may be an example of aspects of a communications manager 1720, a communications manager 1820, or both, as described herein. The communications manager 1920, or various components thereof, may be an example of means for performing various aspects of methods for usage of a RIS in wireless communications as described herein. For example, the communications manager 1920 may include a RIS mode manager 1925, a reflecting mode manager 1930, a second mode manager 1935, an SSB manager 1940, or any combination thereof. Each of these components may communicate, directly or indirectly, with one another (e.g., via one or more buses).

The communications manager 1920 may support wireless communications at a RIS in accordance with examples as disclosed herein. The RIS mode manager 1925 may be configured as or otherwise support a means for receiving, from a base station, a message instructing the RIS to operate in a first mode for each of a set of multiple transmissions from the base station and to operate in a second mode for a probe transmission from the base station, where each of the set of multiple transmissions and the probe transmission are associated with a same beam direction. The reflecting mode manager 1930 may be configured as or otherwise support a means for reflecting, by the RIS operating in the first mode, the set of multiple transmissions from the base station. The second mode manager 1935 may be configured as or otherwise support a means for refraining from reflecting, by the RIS operating in the second mode, the probe transmission from the base station.

In some examples, to support operating in the first mode, the reflecting mode manager 1930 may be configured as or otherwise support a means for operating in a reflecting mode.

In some examples, to support operating in the second mode, the second mode manager 1935 may be configured as or otherwise support a means for operating in a scattering mode or in a transparent mode.

In some examples, the SSB manager 1940 may be configured as or otherwise support a means for receiving a second message indicating a set of multiple synchronization signal block indices, where each of the set of multiple transmissions and the probe transmission includes a synchronization signal block signal associated with a respective synchronization signal block index.

In some examples, the probe transmission is associated with one of a lowest index or a highest index of the set of multiple synchronization signal block indices.

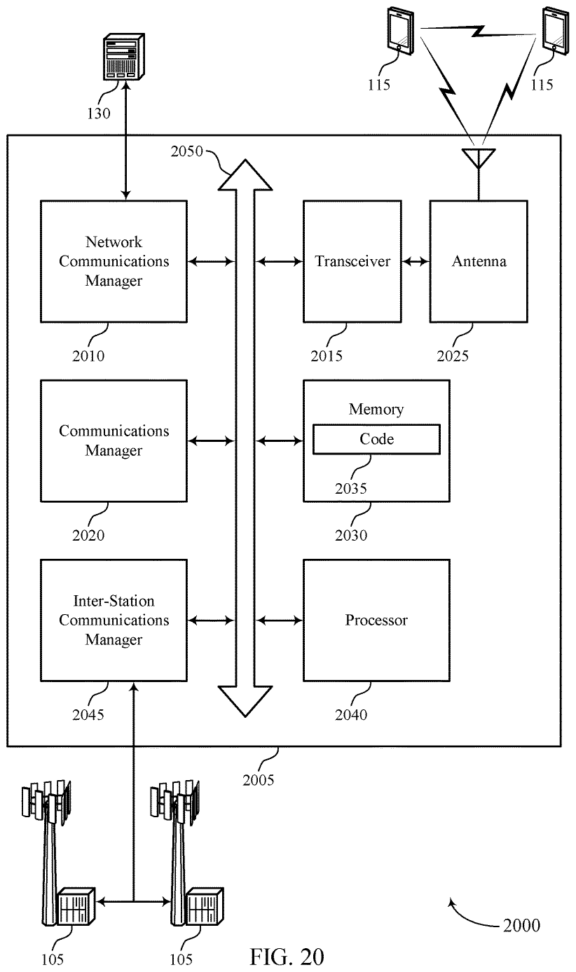

FIG. 20 shows a diagram of a system 2000 including a device 2005 that supports methods for usage of a RIS in wireless communications in accordance with aspects of the present disclosure. The device 2005 may be an example of or include the components of a device 1705, a device 1805, or a RIS 225 as described herein. The device 2005 may include components for bi-directional voice and data communications including components for transmitting and receiving communications, such as a communications manager 2020, a network communications manager 2010, a transceiver 2015, an antenna 2025, a memory 2030, code 2035, a processor 2040, and an inter-station communications manager 2045. These components may be in electronic communication or otherwise coupled (e.g., operatively, communicatively, functionally, electronically, electrically) via one or more buses (e.g., a bus 2050).

The network communications manager 2010 may manage communications with a core network 130 (e.g., via one or more wired backhaul links). For example, the network communications manager 2010 may manage the transfer of data communications for client devices, such as one or more UEs 115.

In some cases, the device 2005 may include a single antenna 2025. However, in some other cases the device 2005 may have more than one antenna 2025, which may be capable of concurrently transmitting or receiving multiple wireless transmissions. The transceiver 2015 may communicate bi-directionally, via the one or more antennas 2025, wired, or wireless links as described herein. For example, the transceiver 2015 may represent a wireless transceiver and may communicate bi-directionally with another wireless transceiver. The transceiver 2015 may also include a modem to modulate the packets, to provide the modulated packets to one or more antennas 2025 for transmission, and to demodulate packets received from the one or more antennas 2025. The transceiver 2015, or the transceiver 2015 and one or more antennas 2025, may be an example of a transmitter 1715, a transmitter 1815, a receiver 1710, a receiver 1810, or any combination thereof or component thereof, as described herein.

The memory 2030 may include RAM and ROM. The memory 2030 may store computer-readable, computer-executable code 2035 including instructions that, when executed by the processor 2040, cause the device 2005 to perform various functions described herein. The code 2035 may be stored in a non-transitory computer-readable medium such as system memory or another type of memory. In some cases, the code 2035 may not be directly executable by the processor 2040 but may cause a computer (e.g., when compiled and executed) to perform functions described herein. In some cases, the memory 2030 may contain, among other things, a BIOS which may control basic hardware or software operation such as the interaction with peripheral components or devices.

The processor 2040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 2040 may be configured to operate a memory array using a memory controller. In some other cases, a memory controller may be integrated into the processor 2040. The processor 2040 may be configured to execute computer-readable instructions stored in a memory (e.g., the memory 2030) to cause the device 2005 to perform various functions (e.g., functions or tasks supporting methods for usage of a RIS in wireless communications). For example, the device 2005 or a component of the device 2005 may include a processor 2040 and memory 2030 coupled to the processor 2040, the processor 2040 and memory 2030 configured to perform various functions described herein.

The inter-station communications manager 2045 may manage communications with other base stations 105, and may include a controller or scheduler for controlling communications with UEs 115 in cooperation with other base stations 105. For example, the inter-station communications manager 2045 may coordinate scheduling for transmissions to UEs 115 for various interference mitigation techniques such as beamforming or joint transmission. In some examples, the inter-station communications manager 2045 may provide an X2 interface within an LTE/LTE-A wireless communications network technology to provide communication between base stations 105.

The communications manager 2020 may support wireless communications at a RIS in accordance with examples as disclosed herein. For example, the communications manager 2020 may be configured as or otherwise support a means for receiving, from a base station, a message instructing the RIS to operate in a first mode for each of a set of multiple transmissions from the base station and to operate in a second mode for a probe transmission from the base station, where each of the set of multiple transmissions and the probe transmission are associated with a same beam direction. The communications manager 2020 may be configured as or otherwise support a means for reflecting, by the RIS operating in the first mode, the set of multiple transmissions from the base station. The communications manager 2020 may be configured as or otherwise support a means for refraining from reflecting, by the RIS operating in the second mode, the probe transmission from the base station.

By including or configuring the communications manager 2020 in accordance with examples as described herein, the device 2005 may support techniques for improved communication reliability, more efficient utilization of communication resources, and improved coordination between devices by using techniques for determining when to use a RIS for communications between a UE and a base station.

In some examples, the communications manager 2020 may be configured to perform various operations (e.g., receiving, monitoring, transmitting) using or otherwise in cooperation with the transceiver 2015, the one or more antennas 2025, or any combination thereof. Although the communications manager 2020 is illustrated as a separate component, in some examples, one or more functions described with reference to the communications manager 2020 may be supported by or performed by the processor 2040, the memory 2030, the code 2035, or any combination thereof. For example, the code 2035 may include instructions executable by the processor 2040 to cause the device 2005 to perform various aspects of methods for usage of a RIS in wireless communications as described herein, or the processor 2040 and the memory 2030 may be otherwise configured to perform or support such operations.

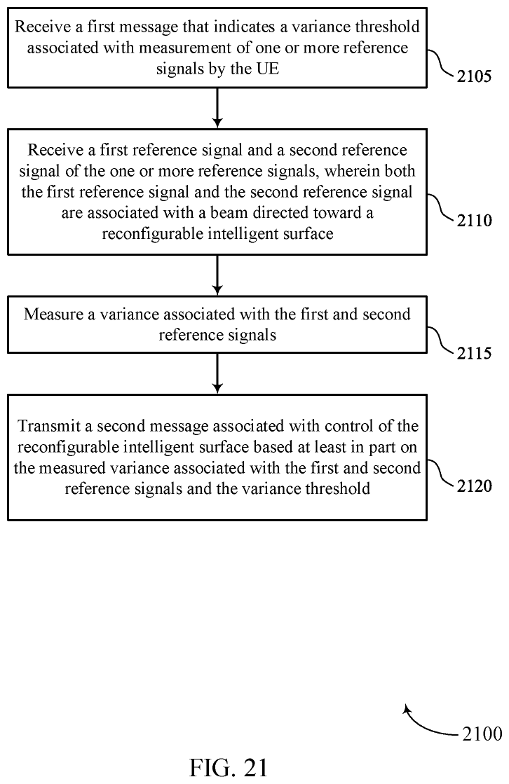

FIG. 21 shows a flowchart illustrating a method 2100 that supports methods for usage of a RIS in wireless communications in accordance with aspects of the present disclosure. The operations of the method 2100 may be implemented by a UE or its components as described herein. For example, the operations of the method 2100 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 2105, the method may include receiving a first message that indicates a variance threshold associated with measurement of one or more reference signals by the UE. The operations of 2105 may be performed in accordance with examples as disclosed herein. In some examples, aspects of the operations of 2105 may be performed by a variance threshold manager 1125 as described with reference to FIG. 11.

At 2110, the method may include receiving a first reference signal and a second reference signal of the one or more reference signals, where both the first reference signal and the second reference signal are associated with a beam directed toward a RIS. The operations of 2110 may be performed in accordance with examples as disclosed herein. In some examples, aspects of the operations of 2110 may be performed by a reference signal manager 1130 as described with reference to FIG. 11.

At 2115, the method may include measuring a variance associated with the first and second reference signals. The operations of 2115 may be performed in accordance with examples as disclosed herein. In some examples, aspects of the operations of 2115 may be performed by a variance measurement manager 1135 as described with reference to FIG. 11.

At 2120, the method may include transmitting a second message associated with control of the RIS based on the measured variance associated with the first and second reference signals and the variance threshold. The operations of 2120 may be performed in accordance with examples as disclosed herein. In some examples, aspects of the operations of 2120 may be performed by a RIS manager 1140 as described with reference to FIG. 11.

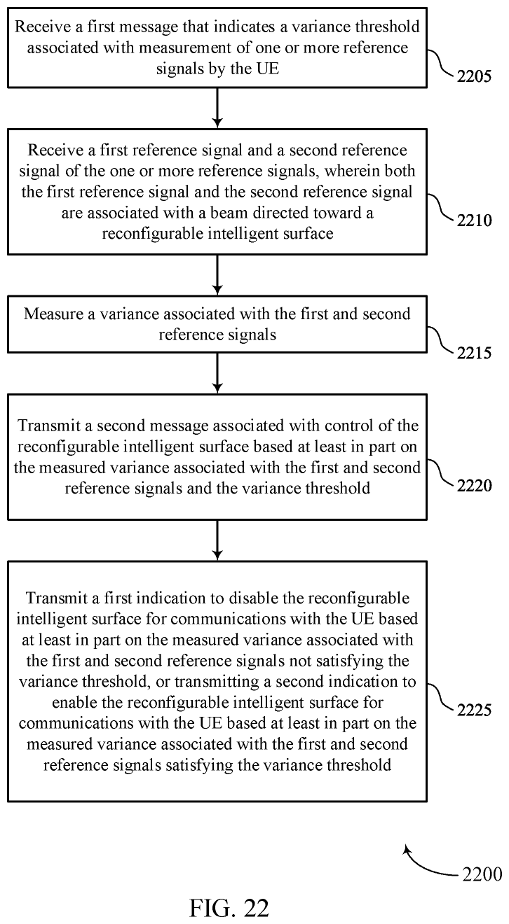

FIG. 22 shows a flowchart illustrating a method 2200 that supports methods for usage of a RIS in wireless communications in accordance with aspects of the present disclosure. The operations of the method 2200 may be implemented by a UE or its components as described herein. For example, the operations of the method 2200 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 2205, the method may include receiving a first message that indicates a variance threshold associated with measurement of one or more reference signals by the UE. The operations of 2205 may be performed in accordance with examples as disclosed herein. In some examples, aspects of the operations of 2205 may be performed by a variance threshold manager 1125 as described with reference to FIG. 11.

At 2210, the method may include receiving a first reference signal and a second reference signal of the one or more reference signals, where both the first reference signal and the second reference signal are associated with a beam directed toward a RIS. The operations of 2210 may be performed in accordance with examples as disclosed herein. In some examples, aspects of the operations of 2210 may be performed by a reference signal manager 1130 as described with reference to FIG. 11.

At 2215, the method may include measuring a variance associated with the first and second reference signals. The operations of 2215 may be performed in accordance with examples as disclosed herein. In some examples, aspects of the operations of 2215 may be performed by a variance measurement manager 1135 as described with reference to FIG. 11.

At 2220, the method may include transmitting a second message associated with control of the RIS based on the measured variance associated with the first and second reference signals and the variance threshold. The operations of 2220 may be performed in accordance with examples as disclosed herein. In some examples, aspects of the operations of 2220 may be performed by a RIS manager 1140 as described with reference to FIG. 11.

At 2225, the method may include transmitting a first indication to disable the RIS for communications with the UE based on the measured variance associated with the first and second reference signals not satisfying the variance threshold, or transmitting a second indication to enable the RIS for communications with the UE based on the measured variance associated with the first and second reference signals satisfying the variance threshold. The operations of 2225 may be performed in accordance with examples as disclosed herein. In some examples, aspects of the operations of 2225 may be performed by a RIS manager 1140 as described with reference to FIG. 11.

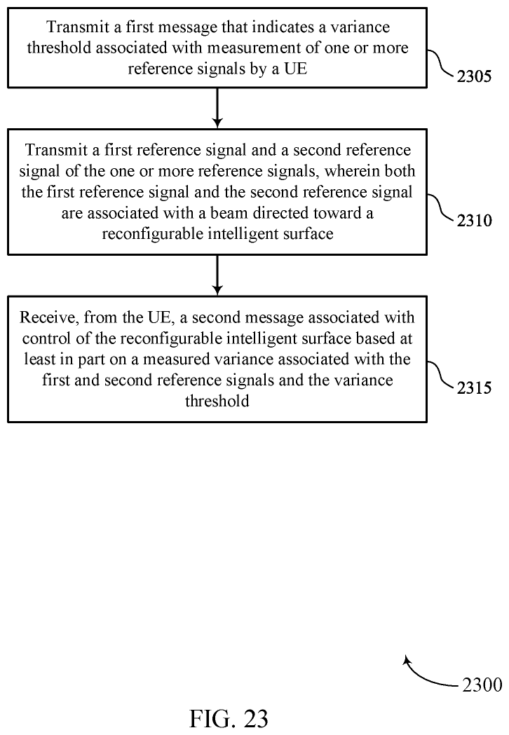

FIG. 23 shows a flowchart illustrating a method 2300 that supports methods for usage of a RIS in wireless communications in accordance with aspects of the present disclosure. The operations of the method 2300 may be implemented by a base station or its components as described herein. For example, the operations of the method 2300 may be performed by a base station 105 as described with reference to FIGS. 1 through 8 and 13 through 16. In some examples, a base station may execute a set of instructions to control the functional elements of the base station to perform the described functions. Additionally or alternatively, the base station may perform aspects of the described functions using special-purpose hardware.

At 2305, the method may include transmitting a first message that indicates a variance threshold associated with measurement of one or more reference signals by a UE. The operations of 2305 may be performed in accordance with examples as disclosed herein. In some examples, aspects of the operations of 2305 may be performed by a variance threshold manager 1525 as described with reference to FIG. 15.

At 2310, the method may include transmitting a first reference signal and a second reference signal of the one or more reference signals, where both the first reference signal and the second reference signal are associated with a beam directed toward a RIS. The operations of 2310 may be performed in accordance with examples as disclosed herein. In some examples, aspects of the operations of 2310 may be performed by a reference signal manager 1530 as described with reference to FIG. 15.

At 2315, the method may include receiving, from the UE, a second message associated with control of the RIS based on a measured variance associated with the first and second reference signals and the variance threshold. The operations of 2315 may be performed in accordance with examples as disclosed herein. In some examples, aspects of the operations of 2315 may be performed by a RIS manager 1535 as described with reference to FIG. 15.

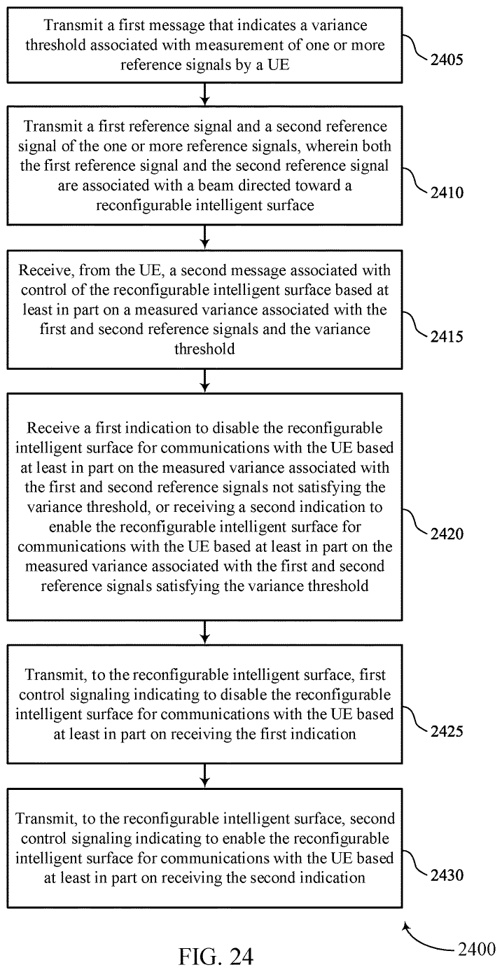

FIG. 24 shows a flowchart illustrating a method 2400 that supports methods for usage of a RIS in wireless communications in accordance with aspects of the present disclosure. The operations of the method 2400 may be implemented by a base station or its components as described herein. For example, the operations of the method 2400 may be performed by a base station 105 as described with reference to FIGS. 1 through 8 and 13 through 16. In some examples, a base station may execute a set of instructions to control the functional elements of the base station to perform the described functions. Additionally or alternatively, the base station may perform aspects of the described functions using special-purpose hardware.

At 2405, the method may include transmitting a first message that indicates a variance threshold associated with measurement of one or more reference signals by a UE. The operations of 2405 may be performed in accordance with examples as disclosed herein. In some examples, aspects of the operations of 2405 may be performed by a variance threshold manager 1525 as described with reference to FIG. 15.

At 2410, the method may include transmitting a first reference signal and a second reference signal of the one or more reference signals, where both the first reference signal and the second reference signal are associated with a beam directed toward a RIS. The operations of 2410 may be performed in accordance with examples as disclosed herein. In some examples, aspects of the operations of 2410 may be performed by a reference signal manager 1530 as described with reference to FIG. 15.

At 2415, the method may include receiving, from the UE, a second message associated with control of the RIS based on a measured variance associated with the first and second reference signals and the variance threshold. The operations of 2415 may be performed in accordance with examples as disclosed herein. In some examples, aspects of the operations of 2415 may be performed by a RIS manager 1535 as described with reference to FIG. 15.

At 2420, the method may include receiving a first indication to disable the RIS for communications with the UE based on the measured variance associated with the first and second reference signals not satisfying the variance threshold, or receiving a second indication to enable the RIS for communications with the UE based on the measured variance associated with the first and second reference signals satisfying the variance threshold. The operations of 2420 may be performed in accordance with examples as disclosed herein. In some examples, aspects of the operations of 2420 may be performed by a RIS manager 1535 as described with reference to FIG. 15.

At 2425, the method may include transmitting, to the RIS, first control signaling indicating to disable the RIS for communications with the UE based on receiving the first indication. The operations of 2425 may be performed in accordance with examples as disclosed herein. In some examples, aspects of the operations of 2425 may be performed by a RIS manager 1535 as described with reference to FIG. 15.

At 2430, the method may include transmitting, to the RIS, second control signaling indicating to enable the RIS for communications with the UE based on receiving the second indication. The operations of 2430 may be performed in accordance with examples as disclosed herein. In some examples, aspects of the operations of 2430 may be performed by a RIS manager 1535 as described with reference to FIG. 15.

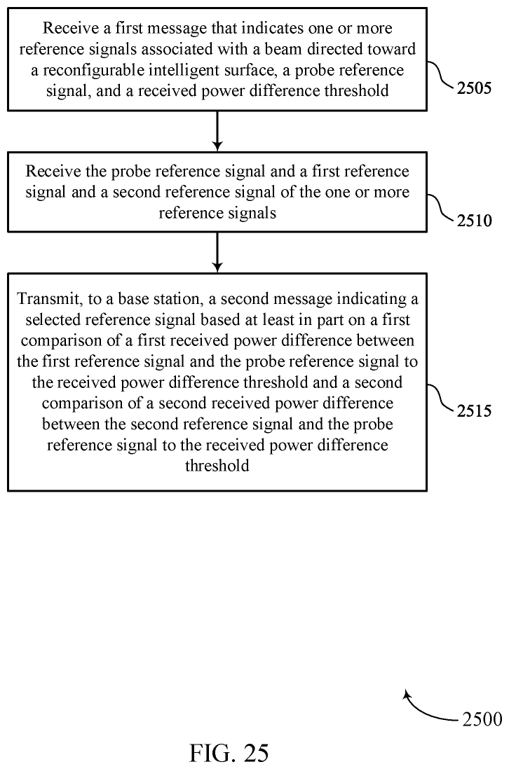

FIG. 25 shows a flowchart illustrating a method 2500 that supports methods for usage of a RIS in wireless communications in accordance with aspects of the present disclosure. The operations of the method 2500 may be implemented by a UE or its components as described herein. For example, the operations of the method 2500 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 2505, the method may include receiving a first message that indicates one or more reference signals associated with a beam directed toward a RIS, a probe reference signal, and a received power difference threshold. The operations of 2505 may be performed in accordance with examples as disclosed herein. In some examples, aspects of the operations of 2505 may be performed by a probe signal manager 1145 as described with reference to FIG. 11.

At 2510, the method may include receiving the probe reference signal and a first reference signal and a second reference signal of the one or more reference signals. The operations of 2510 may be performed in accordance with examples as disclosed herein. In some examples, aspects of the operations of 2510 may be performed by a reference signal manager 1130 as described with reference to FIG. 11.

At 2515, the method may include transmitting, to a base station, a second message indicating a selected reference signal based on a first comparison of a first received power difference between the first reference signal and the probe reference signal to the received power difference threshold and a second comparison of a second received power difference between the second reference signal and the probe reference signal to the received power difference threshold. The operations of 2515 may be performed in accordance with examples as disclosed herein. In some examples, aspects of the operations of 2515 may be performed by a received power difference manager 1150 as described with reference to FIG. 11.

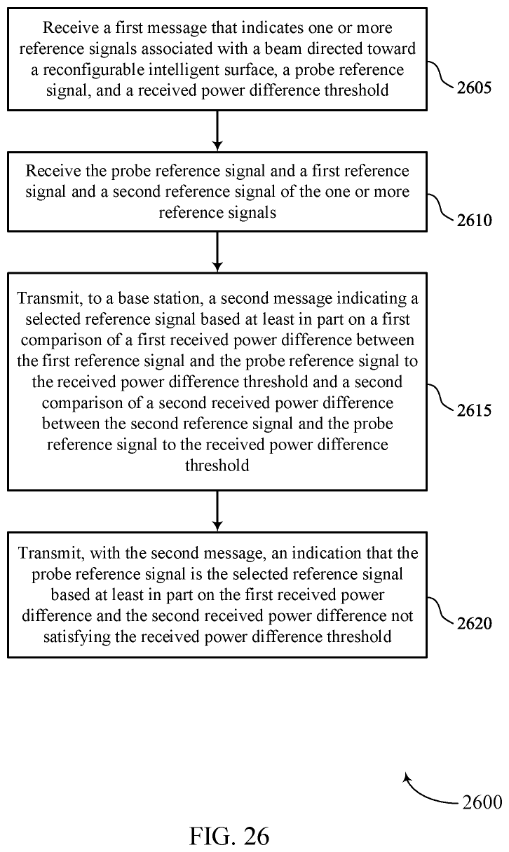

FIG. 26 shows a flowchart illustrating a method 2600 that supports methods for usage of a RIS in wireless communications in accordance with aspects of the present disclosure. The operations of the method 2600 may be implemented by a UE or its components as described herein. For example, the operations of the method 2600 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 2605, the method may include receiving a first message that indicates one or more reference signals associated with a beam directed toward a RIS, a probe reference signal, and a received power difference threshold. The operations of 2605 may be performed in accordance with examples as disclosed herein. In some examples, aspects of the operations of 2605 may be performed by a probe signal manager 1145 as described with reference to FIG. 11.

At 2610, the method may include receiving the probe reference signal and a first reference signal and a second reference signal of the one or more reference signals. The operations of 2610 may be performed in accordance with examples as disclosed herein. In some examples, aspects of the operations of 2610 may be performed by a reference signal manager 1130 as described with reference to FIG. 11.

At 2615, the method may include transmitting, to a base station, a second message indicating a selected reference signal based on a first comparison of a first received power difference between the first reference signal and the probe reference signal to the received power difference threshold and a second comparison of a second received power difference between the second reference signal and the probe reference signal to the received power difference threshold. The operations of 2615 may be performed in accordance with examples as disclosed herein. In some examples, aspects of the operations of 2615 may be performed by a received power difference manager 1150 as described with reference to FIG. 11.

At 2620, the method may include transmitting, with the second message, an indication that the probe reference signal is the selected reference signal based on the first received power difference and the second received power difference not satisfying the received power difference threshold. The operations of 2620 may be performed in accordance with examples as disclosed herein. In some examples, aspects of the operations of 2620 may be performed by a received power difference manager 1150 as described with reference to FIG. 11.

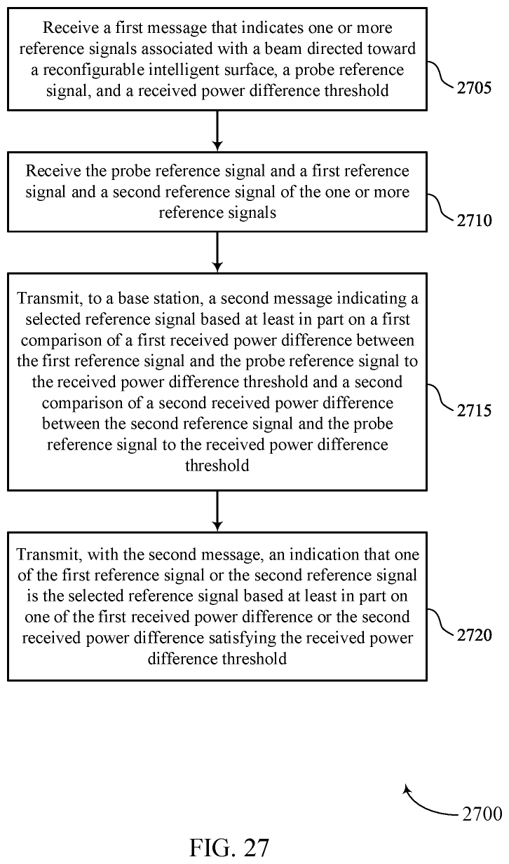

FIG. 27 shows a flowchart illustrating a method 2700 that supports methods for usage of a RIS in wireless communications in accordance with aspects of the present disclosure. The operations of the method 2700 may be implemented by a UE or its components as described herein. For example, the operations of the method 2700 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 2705, the method may include receiving a first message that indicates one or more reference signals associated with a beam directed toward a RIS, a probe reference signal, and a received power difference threshold. The operations of 2705 may be performed in accordance with examples as disclosed herein. In some examples, aspects of the operations of 2705 may be performed by a probe signal manager 1145 as described with reference to FIG. 11.

At 2710, the method may include receiving the probe reference signal and a first reference signal and a second reference signal of the one or more reference signals. The operations of 2710 may be performed in accordance with examples as disclosed herein. In some examples, aspects of the operations of 2710 may be performed by a reference signal manager 1130 as described with reference to FIG. 11.

At 2715, the method may include transmitting, to a base station, a second message indicating a selected reference signal based on a first comparison of a first received power difference between the first reference signal and the probe reference signal to the received power difference threshold and a second comparison of a second received power difference between the second reference signal and the probe reference signal to the received power difference threshold. The operations of 2715 may be performed in accordance with examples as disclosed herein. In some examples, aspects of the operations of 2715 may be performed by a received power difference manager 1150 as described with reference to FIG. 11.

At 2720, the method may include transmitting, with the second message, an indication that one of the first reference signal or the second reference signal is the selected reference signal based on one of the first received power difference or the second received power difference satisfying the received power difference threshold.

The operations of 2720 may be performed in accordance with examples as disclosed herein. In some examples, aspects of the operations of 2720 may be performed by a received power difference manager 1150 as described with reference to FIG. 11.

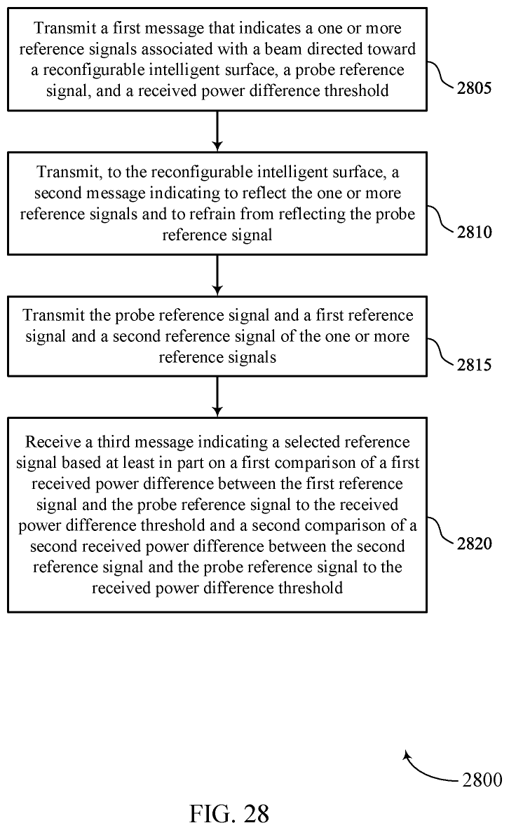

FIG. 28 shows a flowchart illustrating a method 2800 that supports methods for usage of a RIS in wireless communications in accordance with aspects of the present disclosure. The operations of the method 2800 may be implemented by a base station or its components as described herein. For example, the operations of the method 2800 may be performed by a base station 105 as described with reference to FIGS. 1 through 8 and 13 through 16. In some examples, a base station may execute a set of instructions to control the functional elements of the base station to perform the described functions. Additionally or alternatively, the base station may perform aspects of the described functions using special-purpose hardware.

At 2805, the method may include transmitting a first message that indicates one or more reference signals associated with a beam directed toward a RIS, a probe reference signal, and a received power difference threshold. The operations of 2805 may be performed in accordance with examples as disclosed herein. In some examples, aspects of the operations of 2805 may be performed by a probe signal manager 1540 as described with reference to FIG. 15.

At 2810, the method may include transmitting, to the RIS, a second message indicating to reflect the one or more reference signals and to refrain from reflecting the probe reference signal. The operations of 2810 may be performed in accordance with examples as disclosed herein. In some examples, aspects of the operations of 2810 may be performed by a RIS manager 1535 as described with reference to FIG. 15.

At 2815, the method may include transmitting the probe reference signal and a first reference signal and a second reference signal of the one or more reference signals. The operations of 2815 may be performed in accordance with examples as disclosed herein. In some examples, aspects of the operations of 2815 may be performed by a reference signal manager 1530 as described with reference to FIG. 15.

At 2820, the method may include receiving a third message indicating a selected reference signal based on a first comparison of a first received power difference between the first reference signal and the probe reference signal to the received power difference threshold and a second comparison of a second received power difference between the second reference signal and the probe reference signal to the received power difference threshold. The operations of 2820 may be performed in accordance with examples as disclosed herein. In some examples, aspects of the operations of 2820 may be performed by a received power difference manager 1545 as described with reference to FIG. 15.

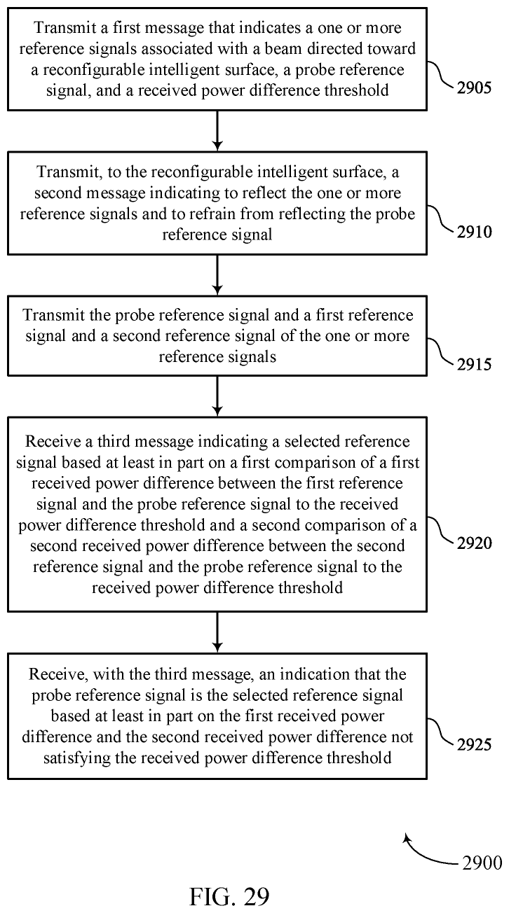

FIG. 29 shows a flowchart illustrating a method 2900 that supports methods for usage of a RIS in wireless communications in accordance with aspects of the present disclosure. The operations of the method 2900 may be implemented by a base station or its components as described herein. For example, the operations of the method 2900 may be performed by a base station 105 as described with reference to FIGS. 1 through 8 and 13 through 16. In some examples, a base station may execute a set of instructions to control the functional elements of the base station to perform the described functions. Additionally or alternatively, the base station may perform aspects of the described functions using special-purpose hardware.

At 2905, the method may include transmitting a first message that indicates one or more reference signals associated with a beam directed toward a RIS, a probe reference signal, and a received power difference threshold. The operations of 2905 may be performed in accordance with examples as disclosed herein. In some examples, aspects of the operations of 2905 may be performed by a probe signal manager 1540 as described with reference to FIG. 15.

At 2910, the method may include transmitting, to the RIS, a second message indicating to reflect the one or more reference signals and to refrain from reflecting the probe reference signal. The operations of 2910 may be performed in accordance with examples as disclosed herein. In some examples, aspects of the operations of 2910 may be performed by a RIS manager 1535 as described with reference to FIG. 15.

At 2915, the method may include transmitting the probe reference signal and a first reference signal and a second reference signal of the one or more reference signals. The operations of 2915 may be performed in accordance with examples as disclosed herein. In some examples, aspects of the operations of 2915 may be performed by a reference signal manager 1530 as described with reference to FIG. 15.

At 2920, the method may include receiving a third message indicating a selected reference signal based on a first comparison of a first received power difference between the first reference signal and the probe reference signal to the received power difference threshold and a second comparison of a second received power difference between the second reference signal and the probe reference signal to the received power difference threshold. The operations of 2920 may be performed in accordance with examples as disclosed herein. In some examples, aspects of the operations of 2920 may be performed by a received power difference manager 1545 as described with reference to FIG. 15.

At 2925, the method may include receiving, with the third message, an indication that the probe reference signal is the selected reference signal based on the first received power difference and the second received power difference not satisfying the received power difference threshold. The operations of 2925 may be performed in accordance with examples as disclosed herein. In some examples, aspects of the operations of 2925 may be performed by a received power difference manager 1545 as described with reference to FIG. 15.

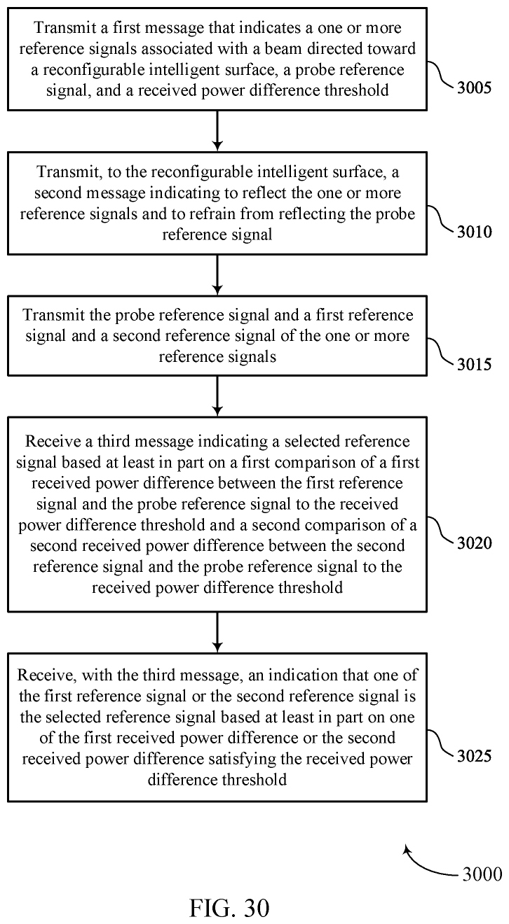

FIG. 30 shows a flowchart illustrating a method 3000 that supports methods for usage of a RIS in wireless communications in accordance with aspects of the present disclosure. The operations of the method 3000 may be implemented by a base station or its components as described herein. For example, the operations of the method 3000 may be performed by a base station 105 as described with reference to FIGS. 1 through 8 and 13 through 16. In some examples, a base station may execute a set of instructions to control the functional elements of the base station to perform the described functions. Additionally or alternatively, the base station may perform aspects of the described functions using special-purpose hardware.

At 3005, the method may include transmitting a first message that indicates one or more reference signals associated with a beam directed toward a RIS, a probe reference signal, and a received power difference threshold. The operations of 3005 may be performed in accordance with examples as disclosed herein. In some examples, aspects of the operations of 3005 may be performed by a probe signal manager 1540 as described with reference to FIG. 15.

At 3010, the method may include transmitting, to the RIS, a second message indicating to reflect the one or more reference signals and to refrain from reflecting the probe reference signal. The operations of 3010 may be performed in accordance with examples as disclosed herein. In some examples, aspects of the operations of 3010 may be performed by a RIS manager 1535 as described with reference to FIG. 15.

At 3015, the method may include transmitting the probe reference signal and a first reference signal and a second reference signal of the one or more reference signals. The operations of 3015 may be performed in accordance with examples as disclosed herein. In some examples, aspects of the operations of 3015 may be performed by a reference signal manager 1530 as described with reference to FIG. 15.

At 3020, the method may include receiving a third message indicating a selected reference signal based on a first comparison of a first received power difference between the first reference signal and the probe reference signal to the received power difference threshold and a second comparison of a second received power difference between the second reference signal and the probe reference signal to the received power difference threshold. The operations of 3020 may be performed in accordance with examples as disclosed herein. In some examples, aspects of the operations of 3020 may be performed by a received power difference manager 1545 as described with reference to FIG. 15.

At 3025, the method may include receiving, with the third message, an indication that one of the first reference signal or the second reference signal is the selected reference signal based on one of the first received power difference or the second received power difference satisfying the received power difference threshold.

The operations of 3025 may be performed in accordance with examples as disclosed herein. In some examples, aspects of the operations of 3025 may be performed by a received power difference manager 1545 as described with reference to FIG. 15.

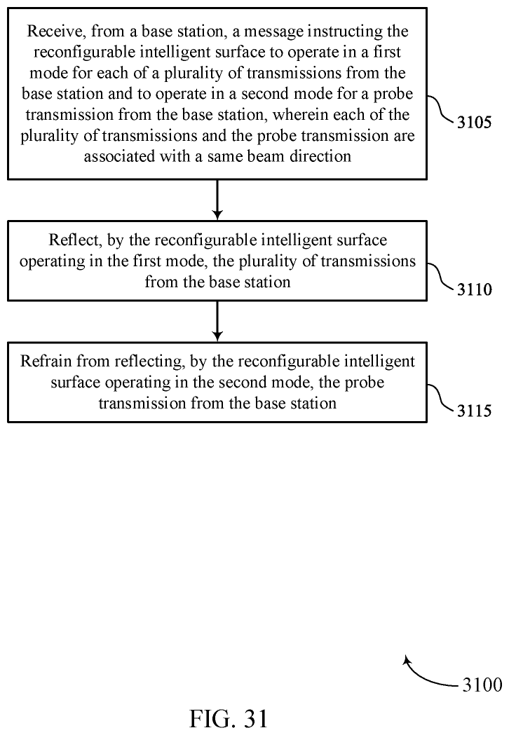

FIG. 31 shows a flowchart illustrating a method 3100 that supports methods for usage of a RIS in wireless communications in accordance with aspects of the present disclosure. The operations of the method 3100 may be implemented by a RIS 225 or its components as described herein. For example, the operations of the method 3100 may be performed by a RIS 225 as described with reference to FIGS. 1 through 8 and 17 through 20. In some examples, a RIS may execute a set of instructions to control the functional elements of the RIS to perform the described functions. Additionally or alternatively, the RIS may perform aspects of the described functions using special-purpose hardware.

At 3105, the method may include receiving, from a base station, a message instructing the RIS to operate in a first mode for each of a set of multiple transmissions from the base station and to operate in a second mode for a probe transmission from the base station, where each of the set of multiple transmissions and the probe transmission are associated with a same beam direction. The operations of 3105 may be performed in accordance with examples as disclosed herein. In some examples, aspects of the operations of 3105 may be performed by a RIS mode manager 1925 as described with reference to FIG. 19.

At 3110, the method may include reflecting, by the RIS operating in the first mode, the set of multiple transmissions from the base station. The operations of 3110 may be performed in accordance with examples as disclosed herein. In some examples, aspects of the operations of 3110 may be performed by a reflecting mode manager 1930 as described with reference to FIG. 19.

At 3115, the method may include refraining from reflecting, by the RIS operating in the second mode, the probe transmission from the base station. The operations of 3115 may be performed in accordance with examples as disclosed herein. In some examples, aspects of the operations of 3115 may be performed by a second mode manager 1935 as described with reference to FIG. 19.

The following provides an overview of aspects of the present disclosure:

Aspect 1: A method for wireless communications at a UE, comprising: receiving a first message that indicates a variance threshold associated with measurement of one or more reference signals by the UE; receiving a first reference signal and a second reference signal of the one or more reference signals, wherein both the first reference signal and the second reference signal are associated with a beam directed toward a RIS; measuring a variance associated with the first and second reference signals; and transmitting a second message associated with control of the RIS based at least in part on the measured variance associated with the first and second reference signals and the variance threshold.

Aspect 2: The method of aspect 1, further comprising: receiving a third message indicating a plurality of synchronization signal block indices, wherein each of the one or more reference signals comprises a respective synchronization signal block signal associated with a respective synchronization signal block index.

Aspect 3: The method of aspect 2, wherein receiving the third message comprises: receiving a raster grid comprising frequency positions associated with the RIS.

Aspect 4: The method of aspect 3, further comprising: monitoring one or more resource elements for the respective synchronization signal block signals based at least in part on the raster grid, wherein receiving the first reference signal and the second reference signal is based at least in part on the monitoring.

Aspect 5: The method of any of aspects 1 through 4, wherein measuring the variance comprises: measuring a reference signal received power variance associated with the first and second reference signals.

Aspect 6: The method of any of aspects 1 through 5, wherein transmitting the second message comprises: transmitting the second message in a random access procedure transmission.

Aspect 7: The method of any of aspects 1 through 6, wherein transmitting the second message comprises: transmitting a first indication to disable the RIS for communications with the UE based at least in part on the measured variance associated with the first and second reference signals not satisfying the variance threshold, or transmitting a second indication to enable the RIS for communications with the UE based at least in part on the measured variance associated with the first and second reference signals satisfying the variance threshold.

Aspect 8: A method for wireless communications at a base station, comprising: transmitting a first message that indicates a variance threshold associated with measurement of one or more reference signals by a UE; transmitting a first reference signal and a second reference signal of the one or more reference signals, wherein both the first reference signal and the second reference signal are associated with a beam directed toward a RIS; and receiving, from the UE, a second message associated with control of the RIS based at least in part on a measured variance associated with the first and second reference signals and the variance threshold.

Aspect 9: The method of aspect 8, further comprising: transmitting a third message indicating a plurality of synchronization signal block indices, wherein each of the one or more reference signals comprises a respective synchronization signal block signal associated with a respective synchronization signal block index.

Aspect 10: The method of aspect 9, wherein transmitting the third message comprises: transmitting a raster grid comprising frequency positions associated with the RIS.

Aspect 11: The method of any of aspects 8 through 10, wherein receiving the second message comprises: receiving the second message in a random access procedure transmission.

Aspect 12: The method of any of aspects 8 through 11, wherein receiving the second message comprises: receiving a first indication to disable the RIS for communications with the UE based at least in part on the measured variance associated with the first and second reference signals not satisfying the variance threshold, or receiving a second indication to enable the RIS for communications with the UE based at least in part on the measured variance associated with the first and second reference signals satisfying the variance threshold.

Aspect 13: The method of aspect 12, further comprising: transmitting, to the RIS, first control signaling indicating to disable the RIS for communications with the UE based at least in part on receiving the first indication; and transmitting, to the RIS, second control signaling indicating to enable the RIS for communications with the UE based at least in part on receiving the second indication.

Aspect 14: A method for wireless communications at a UE, comprising: receiving a first message that indicates one or more reference signals associated with a beam directed toward a RIS, a probe reference signal, and a received power difference threshold; receiving the probe reference signal and a first reference signal and a second reference signal of the one or more reference signals; and transmitting, to a base station, a second message indicating a selected reference signal based at least in part on a first comparison of a first received power difference between the first reference signal and the probe reference signal to the received power difference threshold and a second comparison of a second received power difference between the second reference signal and the probe reference signal to the received power difference threshold.

Aspect 15: The method of aspect 14, wherein transmitting the second message comprises: transmitting an indication that the probe reference signal is the selected reference signal based at least in part on the first received power difference and the second received power difference not satisfying the received power difference threshold.

Aspect 16: The method of any of aspects 14 through 15, wherein transmitting the second message comprises: transmitting an indication that one of the first reference signal or the second reference signal is the selected reference signal based at least in part on one of the first received power difference or the second received power difference satisfying the received power difference threshold.

Aspect 17: The method of any of aspects 14 through 16, further comprising: receiving a third message indicating a plurality of synchronization signal block indices, wherein each of the one or more reference signals and the probe reference signal comprises a synchronization signal block signal associated with a respective synchronization signal block index.

Aspect 18: The method of aspect 17, wherein receiving the third message comprises: receiving a raster grid comprising frequency positions associated with the RIS.

Aspect 19: The method of aspect 18, further comprising: monitoring one or more resource elements for the respective synchronization signal block signals based at least in part on the raster grid, wherein receiving the probe reference signal and the first reference signal and the second reference signal is based at least in part on the monitoring.

Aspect 20: The method of any of aspects 17 through 19, wherein the probe reference signal is associated with one of a lowest index or a highest index of the plurality of synchronization signal block indices.

Aspect 21: The method of any of aspects 14 through 20, further comprising: measuring a first reference signal received power of the first reference signal, a second reference signal received power of the second reference signal, and a third reference signal received power of the probe reference signal, wherein the first comparison and the second comparison are based at least in part on the first reference signal received power, the second reference signal received power, and the third reference signal received power.

Aspect 22: The method of any of aspects 14 through 21, wherein transmitting the second message comprises: transmitting the second message in a random access procedure transmission.

Aspect 23: A method for wireless communications at a base station, comprising: transmitting a first message that indicates a one or more reference signals associated with a beam directed toward a RIS, a probe reference signal, and a received power difference threshold; transmitting, to the RIS, a second message indicating to reflect the one or more reference signals and to refrain from reflecting the probe reference signal; transmitting the probe reference signal and a first reference signal and a second reference signal of the one or more reference signals; and receiving a third message indicating a selected reference signal based at least in part on a first comparison of a first received power difference between the first reference signal and the probe reference signal to the received power difference threshold and a second comparison of a second received power difference between the second reference signal and the probe reference signal to the received power difference threshold.

Aspect 24: The method of aspect 23, wherein receiving the third message comprises: receiving an indication that the probe reference signal is the selected reference signal based at least in part on the first received power difference and the second received power difference not satisfying the received power difference threshold.

Aspect 25: The method of any of aspects 23 through 24, wherein receiving the third message comprises: receiving an indication that one of the first reference signal or the second reference signal is the selected reference signal based at least in part on one of the first received power difference or the second received power difference satisfying the received power difference threshold.

Aspect 26: The method of any of aspects 23 through 25, further comprising: transmitting a fourth message indicating a plurality of synchronization signal block indices, wherein each of the one or more reference signals and the probe reference signal comprises a synchronization signal block signal associated with a respective synchronization signal block index.

Aspect 27: The method of aspect 26, wherein transmitting the fourth message comprises: transmitting a raster grid comprising frequency positions associated with the RIS.

Aspect 28: The method of any of aspects 26 through 27, wherein the probe reference signal is associated with one of a lowest index or a highest index of the plurality of synchronization signal block indices.

Aspect 29: The method of any of aspects 23 through 28, wherein receiving the third message comprises: receiving the third message in a random access procedure transmission.

Aspect 30: A method for wireless communications at a RIS, comprising: receiving, from a base station, a message instructing the RIS to operate in a first mode for each of a plurality of transmissions from the base station and to operate in a second mode for a probe transmission from the base station, wherein each of the plurality of transmissions and the probe transmission are associated with a same beam direction; reflecting, by the RIS operating in the first mode, the plurality of transmissions from the base station; and refraining from reflecting, by the RIS operating in the second mode, the probe transmission from the base station.

Aspect 31: The method of aspect 30, wherein operating in the first mode comprises: operating in a reflecting mode.

Aspect 32: The method of any of aspects 30 through 31, wherein operating in the second mode comprises: operating in a scattering mode or in a transparent mode.

Aspect 33: The method of any of aspects 30 through 32, further comprising: receiving a second message indicating a plurality of synchronization signal block indices, wherein each of the plurality of transmissions and the probe transmission comprises a synchronization signal block signal associated with a respective synchronization signal block index.

Aspect 34: The method of aspect 33, wherein the probe transmission is associated with one of a lowest index or a highest index of the plurality of synchronization signal block indices.

Aspect 35: An apparatus for wireless communications at a UE, comprising a processor; memory coupled with the processor; and instructions stored in the memory and executable by the processor to cause the apparatus to perform a method of any of aspects 1 through 7.

Aspect 36: An apparatus for wireless communications at a UE, comprising at least one means for performing a method of any of aspects 1 through 7.

Aspect 37: A non-transitory computer-readable medium storing code for wireless communications at a UE, the code comprising instructions executable by a processor to perform a method of any of aspects 1 through 7.

Aspect 38: An apparatus for wireless communications at a base station, comprising a processor; memory coupled with the processor; and instructions stored in the memory and executable by the processor to cause the apparatus to perform a method of any of aspects 8 through 13.

Aspect 39: An apparatus for wireless communications at a base station, comprising at least one means for performing a method of any of aspects 8 through 13.

Aspect 40: A non-transitory computer-readable medium storing code for wireless communications at a base station, the code comprising instructions executable by a processor to perform a method of any of aspects 8 through 13.

Aspect 41: An apparatus for wireless communications at a UE, comprising a processor; memory coupled with the processor; and instructions stored in the memory and executable by the processor to cause the apparatus to perform a method of any of aspects 14 through 22.

Aspect 42: An apparatus for wireless communications at a UE, comprising at least one means for performing a method of any of aspects 14 through 22.

Aspect 43: A non-transitory computer-readable medium storing code for wireless communications at a UE, the code comprising instructions executable by a processor to perform a method of any of aspects 14 through 22.

Aspect 44: An apparatus for wireless communications at a base station, comprising a processor; memory coupled with the processor; and instructions stored in the memory and executable by the processor to cause the apparatus to perform a method of any of aspects 23 through 29.

Aspect 45: An apparatus for wireless communications at a base station, comprising at least one means for performing a method of any of aspects 23 through 29.

Aspect 46: A non-transitory computer-readable medium storing code for wireless communications at a base station, the code comprising instructions executable by a processor to perform a method of any of aspects 23 through 29.

Aspect 47: An apparatus for wireless communications at a RIS, comprising a processor; memory coupled with the processor; and instructions stored in the memory and executable by the processor to cause the apparatus to perform a method of any of aspects 30 through 34.

Aspect 48: An apparatus for wireless communications at a RIS, comprising at least one means for performing a method of any of aspects 30 through 34.

Aspect 49: A non-transitory computer-readable medium storing code for wireless communications at a RIS, the code comprising instructions executable by a processor to perform a method of any of aspects 30 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving a first message that indicates a variance threshold associated with measurement of one or more reference signals by the UE;
receiving a first reference signal and a second reference signal of the one or more reference signals, wherein both the first reference signal and the second reference signal are associated with a beam directed toward a reconfigurable intelligent surface;
measuring a variance associated with the first and second reference signals; and
transmitting a second message associated with control of the reconfigurable intelligent surface based at least in part on the measured variance associated with the first and second reference signals and the variance threshold.

2. The method of claim 1, further comprising:
receiving a third message indicating a plurality of synchronization signal block indices, wherein each of the one or more reference signals comprises a respective synchronization signal block signal associated with a respective synchronization signal block index.

3. The method of claim 2, wherein receiving the third message comprises:
receiving a raster grid comprising frequency positions associated with the reconfigurable intelligent surface.

4. The method of claim 3, further comprising:
monitoring one or more resource elements for the respective synchronization signal block signals based at least in part on the raster grid, wherein receiving the first reference signal and the second reference signal is based at least in part on the monitoring.

5. The method of claim 1, wherein measuring the variance comprises:
measuring a reference signal received power variance associated with the first and second reference signals.

6. The method of claim 1, wherein transmitting the second message comprises:
transmitting the second message in a random access procedure transmission.

7. The method of claim 1, wherein transmitting the second message comprises:
transmitting a first indication to disable the reconfigurable intelligent surface for communications with the UE based at least in part on the measured variance associated with the first and second reference signals not satisfying the variance threshold, or transmitting a second indication to enable the reconfigurable intelligent surface for communications with the UE based at least in part on the measured variance associated with the first and second reference signals satisfying the variance threshold.

8. A method for wireless communications at a base station, comprising:
transmitting a first message that indicates a variance threshold associated with measurement of one or more reference signals by a user equipment (UE);
transmitting a first reference signal and a second reference signal of the one or more reference signals, wherein both the first reference signal and the second reference signal are associated with a beam directed toward a reconfigurable intelligent surface; and
receiving, from the UE, a second message associated with control of the reconfigurable intelligent surface based at least in part on a measured variance associated with the first and second reference signals and the variance threshold.

9. The method of claim 8, further comprising:
transmitting a third message indicating a plurality of synchronization signal block indices, wherein each of the one or more reference signals comprises a respective synchronization signal block signal associated with a respective synchronization signal block index.

10. The method of claim 9, wherein transmitting the third message comprises:
transmitting a raster grid comprising frequency positions associated with the reconfigurable intelligent surface.

11. The method of claim 8, wherein receiving the second message comprises:
receiving the second message in a random access procedure transmission.

12. The method of claim 8, wherein receiving the second message comprises:
receiving a first indication to disable the reconfigurable intelligent surface for communications with the UE based at least in part on the measured variance associated with the first and second reference signals not satisfying the variance threshold, or receiving a second indication to enable the reconfigurable intelligent surface for communications with the UE based at least in part on the measured variance associated with the first and second reference signals satisfying the variance threshold.

13. The method of claim 12, further comprising:
transmitting, to the reconfigurable intelligent surface, first control signaling indicating to disable the reconfigurable intelligent surface for communications with the UE based at least in part on receiving the first indication; and
transmitting, to the reconfigurable intelligent surface, second control signaling indicating to enable the reconfigurable intelligent surface for communications with the UE based at least in part on receiving the second indication.

14. A method for wireless communications at a user equipment (UE), comprising:
receiving a first message that indicates one or more reference signals associated with a beam directed toward a reconfigurable intelligent surface, a probe reference signal, and a received power difference threshold;
receiving the probe reference signal and a first reference signal and a second reference signal of the one or more reference signals; and
transmitting, to a base station, a second message indicating a selected reference signal based at least in part on a first comparison of a first received power difference between the first reference signal and the probe reference signal to the received power difference threshold and a second comparison of a second received power difference between the second reference signal and the probe reference signal to the received power difference threshold.

15. The method of claim 14, wherein transmitting the second message comprises:
transmitting an indication that the probe reference signal is the selected reference signal based at least in part on the first received power difference and the second received power difference not satisfying the received power difference threshold.

16. The method of claim 14, wherein transmitting the second message comprises:
transmitting an indication that one of the first reference signal or the second reference signal is the selected reference signal based at least in part on one of the first received power difference or the second received power difference satisfying the received power difference threshold.

17. The method of claim 14, further comprising:
receiving a third message indicating a plurality of synchronization signal block indices, wherein each of the one or more reference signals and the probe reference signal comprises a synchronization signal block signal associated with a respective synchronization signal block index.

18. The method of claim 17, wherein receiving the third message comprises:
receiving a raster grid comprising frequency positions associated with the reconfigurable intelligent surface.

19. The method of claim 18, further comprising:
monitoring one or more resource elements for the respective synchronization signal block signals based at least in part on the raster grid, wherein receiving the probe reference signal and the first reference signal and the second reference signal is based at least in part on the monitoring.

20. The method of claim 17, wherein the probe reference signal is associated with one of a lowest index or a highest index of the plurality of synchronization signal block indices.

21. The method of claim 14, further comprising:
measuring a first reference signal received power of the first reference signal, a second reference signal received power of the second reference signal, and a third reference signal received power of the probe reference signal, wherein the first comparison and the second comparison are based at least in part on the first reference signal received power, the second reference signal received power, and the third reference signal received power.

22. The method of claim 14, wherein transmitting the second message comprises:
transmitting the second message in a random access procedure transmission.

23. A method for wireless communications at a base station, comprising:
transmitting a first message that indicates one or more reference signals associated with a beam directed toward a reconfigurable intelligent surface, a probe reference signal, and a received power difference threshold;
transmitting, to the reconfigurable intelligent surface, a second message indicating to reflect the one or more reference signals and to refrain from reflecting the probe reference signal;
transmitting the probe reference signal and a first reference signal and a second reference signal of the one or more reference signals; and
receiving a third message indicating a selected reference signal based at least in part on a first comparison of a first received power difference between the first reference signal and the probe reference signal to the received power difference threshold and a second comparison of a second received power difference between the second reference signal and the probe reference signal to the received power difference threshold.

24. The method of claim 23, wherein receiving the third message comprises:
receiving an indication that the probe reference signal is the selected reference signal based at least in part on the first received power difference and the second received power difference not satisfying the received power difference threshold.

25. The method of claim 23, wherein receiving the third message comprises:
receiving an indication that one of the first reference signal or the second reference signal is the selected reference signal based at least in part on one of the first received power difference or the second received power difference satisfying the received power difference threshold.

26. The method of claim 23, further comprising:
transmitting a fourth message indicating a plurality of synchronization signal block indices, wherein each of the one or more reference signals and the probe reference signal comprises a synchronization signal block signal associated with a respective synchronization signal block index.

27. The method of claim 26, wherein transmitting the fourth message comprises:
transmitting a raster grid comprising frequency positions associated with the reconfigurable intelligent surface.

28. The method of claim 26, wherein the probe reference signal is associated with one of a lowest index or a highest index of the plurality of synchronization signal block indices.

29. The method of claim 23, wherein receiving the third message comprises:
receiving the third message in a random access procedure transmission.

30. A method for wireless communications at a reconfigurable intelligent surface, comprising:
receiving, from a base station, a message instructing the reconfigurable intelligent surface to operate in a first mode for each of a plurality of transmissions from the base station and to operate in a second mode for a probe transmission from the base station, wherein each of the plurality of transmissions and the probe transmission are associated with a same beam direction;
reflecting, by the reconfigurable intelligent surface operating in the first mode, the plurality of transmissions from the base station; and
refraining from reflecting, by the reconfigurable intelligent surface operating in the second mode, the probe transmission from the base station.

31. The method of claim 30, wherein operating in the first mode comprises:
operating in a reflecting mode.

32. The method of claim 30, wherein operating in the second mode comprises:
operating in a scattering mode or in a transparent mode.

33. The method of claim 30, further comprising:
receiving a second message indicating a plurality of synchronization signal block indices, wherein each of the plurality of transmissions and the probe transmission comprises a synchronization signal block signal associated with a respective synchronization signal block index.

34. The method of claim 33, wherein the probe transmission is associated with one of a lowest index or a highest index of the plurality of synchronization signal block indices.

35. An apparatus for wireless communications at a user equipment (UE), comprising:
a memory; and
a processor coupled to the memory and configured to:
receive a first message that indicates a variance threshold associated with measurement of one or more reference signals by the UE;
receive a first reference signal and a second reference signal of the one or more reference signals, wherein both the first reference signal and the second reference signal are associated with a beam directed toward a reconfigurable intelligent surface;
measure a variance associated with the first and second reference signals; and
transmit a second message associated with control of the reconfigurable intelligent surface based at least in part on the measured variance associated with the first and second reference signals and the variance threshold.

36. The apparatus of claim 35, wherein processor is further configured to perform a method of any of claims 2 through 7.

37. An apparatus for wireless communications at a base station, comprising:
a memory; and
a processor coupled to the memory and configured to:
transmit a first message that indicates a variance threshold associated with measurement of one or more reference signals by a user equipment (UE);
transmit a first reference signal and a second reference signal of the one or more reference signals, wherein both the first reference signal and the second reference signal are associated with a beam directed toward a reconfigurable intelligent surface; and
receive, from the UE, a second message associated with control of the reconfigurable intelligent surface based at least in part on a measured variance associated with the first and second reference signals and the variance threshold.

38. The apparatus of claim 37, wherein the processor is further configured to perform a method of any of claims 9 through 13.

39. An apparatus for wireless communications at a user equipment (UE), comprising:
a memory; and
a processor coupled to the memory and configured to:
receive a first message that indicates one or more reference signals associated with a beam directed toward a reconfigurable intelligent surface, a probe reference signal, and a received power difference threshold;
receive the probe reference signal and a first reference signal and a second reference signal of the one or more reference signals; and
transmit, to a base station, a second message indicating a selected reference signal based at least in part on a first comparison of a first received power difference between the first reference signal and the probe reference signal to the received power difference threshold and a second comparison of a second received power difference between the second reference signal and the probe reference signal to the received power difference threshold.

40. The apparatus of claim 39, wherein the processor is further configured to perform a method of any of claims 15 through 22.

41. An apparatus for wireless communications at a base station, comprising:
a memory; and
a processor coupled to the memory and configured to:
transmit a first message that indicates one or more reference signals associated with a beam directed toward a reconfigurable intelligent surface, a probe reference signal, and a received power difference threshold;
transmit, to the reconfigurable intelligent surface, a second message indicating to reflect the one or more reference signals and to refrain from reflecting the probe reference signal;
transmit the probe reference signal and a first reference signal and a second reference signal of the one or more reference signals; and
receive a third message indicating a selected reference signal based at least in part on a first comparison of a first received power difference between the first reference signal and the probe reference signal to the received power difference threshold and a second comparison of a second received power difference between the second reference signal and the probe reference signal to the received power difference threshold.

42. The apparatus of claim 41, wherein the processor is further configured to perform a method of any of claims 24 through 29.

43. An apparatus for wireless communications at a reconfigurable intelligent surface, comprising:
a memory; and
a processor coupled to the memory and configured to:
receive, from a base station, a message instructing the reconfigurable intelligent surface to operate in a first mode for each of a plurality of transmissions from the base station and to operate in a second mode for a probe transmission from the base station, wherein each of the plurality of transmissions and the probe transmission are associated with a same beam direction;
reflect, by the reconfigurable intelligent surface operating in the first mode, the plurality of transmissions from the base station; and
refrain from reflecting, by the reconfigurable intelligent surface operating in the second mode, the probe transmission from the base station.

44. The apparatus of claim 43, wherein the processor is further configured to perform a method of any of claims 31-34.
